(19) United States
(12) Patent Application Publication
(10) Pub. No.: US 2024/0202727 A1
(43) Pub. Date: Jun. 20, 2024

(54) TRANSACTION AUTHORIZATION USING BIOMETRIC IDENTITY VERIFICATION

(71) Applicant: IDEX BIOMETRICS ASA, Oslo (NO)

(72) Inventor: Fred George BENKLEY, III, Middleton, MA (US)

(21) Appl. No.: 18/556,924

(22) PCT Filed: May 17, 2022
(86) PCT No.: PCT/US2022/029565

§ 371 Date: Oct. 24, 2023

Related U.S. Application Data
(60) Provisional application No. 63/190,955, filed on May 20, 2021.

(51) Int. Cl. G06Q 20/40; G06Q 20/38

(52) U.S. Cl. CPC G06Q 20/40145; G06Q 20/382; G06Q 20/4018

(57) ABSTRACT

A system for card not present (CNP) transaction authorization includes a smart card having a biometric sensor, a processor, and memory, the processor and memory comprising logic, a host device configured to communicate with the smart card, the host device configured to provide temporary power to the smart card, the biometric sensor and logic configured to capture one or more current biometric features corresponding to a current user identity sample, compare the one or more current biometric features to a previously obtained biometric feature corresponding to a previously obtained user identity sample, and if the one or more current biometric features matches the previously obtained biometric feature, generate an authorization signal that identifies the current user identity sample as belonging to an authorized user, the authorization signal corresponding to a user initiated successful biometric user authentication, the logic configured to generate a temporary passcode for display on the host device, the temporary passcode being used to authorize at least one transaction, the temporary passcode being generated from a combination of the authorization signal, fixed information previously stored securely on the card, and a dynamically changing variable, the temporary passcode being capable of being shared between the host device and the smart card.

### BACKGROUND

The volume of on-line credit and debit card transactions are expected to soon overtake the number of in-person transactions. On-line transactions fall into a category of transactions that are referred to as card not present (CNP) transactions. A CNP transaction using current technology generally has a significantly higher level of fraud risk than an in-person transaction (also referred to as a card present (CP) transaction) because there is no real time way to prove that a CNP transaction was actually initiated by the authorized owner of the card or whether the transaction was initiated by someone who fraudulently had obtained the card owner's credit card number, expiration date, and card verification value (CVV) code. For example, in a CNP transaction, the card user's identity cannot easily be verified and authenticated because the entire transaction is initiated and performed remotely, the user therefore cannot prove their identity through traditional in-person means such as a picture ID.

Modern chip and pin enabled credit and debit cards, also referred to as smart cards, may include one or more features including, for example, a secure processor often referred to as a Secure Element (SE) with encrypted memory, a display, a data input device, a fixed CVV code or a dynamic card verification value (DCVV, dynamic CVV) generated by on card hardware and software, and one or more biometric sensors or readers. For example, a modern smart card may include a biometric fingerprint sensor, reader circuitry, and processing circuitry that may be configured to store information, such as a fingerprint of the authorized user of the smart card providing live user verification that has been demonstrated to significantly reduce fraud for in-person transactions. To date however these technologies have not been adequately configured to comprehensively address the additional challenges of securing online transactions in a cost-effective manner.

### SUMMARY

In an exemplary embodiment, a system for card not present (CNP) transaction authorization includes a smart card having a biometric sensor, a processor, and memory, the processor and memory comprising logic, a host device configured to communicate with the smart card, the host device configured to provide temporary power to the smart card, the biometric sensor and logic configured to capture one or more current biometric features corresponding to a current user identity sample, compare the one or more current biometric features to a previously obtained biometric feature corresponding to a previously obtained user identity sample, and if the one or more current biometric features matches the previously obtained biometric feature, generate an authorization signal that identifies the current user identity sample as belonging to an authorized user, the authorization signal corresponding to a user initiated successful biometric user authentication. The logic may also be configured to generate a temporary passcode for display on the host device, the temporary passcode being used to authorize at least one transaction, the temporary passcode being generated from a combination of the authorization signal, fixed information previously stored securely on the card, and a dynamically changing variable, the temporary passcode being capable of being shared between the host device and the smart card.

In another exemplary embodiment, a system for card not present (CNP) transaction authorization includes a smart card having a biometric sensor, a host device comprising a display, a processor, and memory, the processor and memory comprising logic, the host device configured to communicate with the smart card, the host device configured to provide temporary power to the smart card, the biometric sensor and logic configured to capture one or more current biometric features corresponding to a current user identity sample, compare the one or more current biometric features to a previously obtained biometric feature corresponding to a previously obtained user identity sample, and if the one or more current biometric features matches the previously obtained biometric feature, generate an authorization signal that identifies the current user identity sample as belonging to an authorized user, the authorization signal corresponding to a user initiated successful biometric user authentication. The logic may also be configured to generate a temporary passcode for display on the host device, the temporary passcode being used to authorize at least one transaction, the temporary passcode being generated from a combination of the authorization signal, fixed information previously stored securely on the card, and a dynamically changing variable.

In another exemplary embodiment, a method for card not present (CNP) transaction authorization includes establishing a communication link between a host device and a smart card, temporarily powering the smart card from a host device, the host device communicating with the smart card, capturing one or more current biometric features corresponding to a current user identity sample, comparing the one or more current biometric features to a previously obtained biometric feature corresponding to a previously obtained user identity sample, if the one or more current biometric features matches the previously obtained biometric feature, generating an authorization signal that identifies the current user identity sample as belonging to an authorized user, the authorization signal corresponding to a user initiated successful biometric user authentication. The method also includes generating from the authorization signal, a temporary passcode, the temporary passcode being generated from a combination of the authorization signal, fixed information previously stored securely on the card, and a dynamically changing variable, and authorizing at least one transaction using the temporary passcode.

Other systems, methods, features, and advantages will be or become apparent to one with skill in the art upon examination of the following figures and detailed description. It is intended that all such additional systems, methods, features, and advantages be included within this description, be within the scope of the specification, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 illustrates a biometric sensor assembly or a biometric sensor, such as fingerprint sensor, installed on a smart card according to some embodiments.

FIG. 2 illustrates an alternative exemplary embodiment of a biometric sensor assembly or a biometric sensor, such as fingerprint sensor, installed on a smart card according to some embodiments.

FIGS. 3A, 3B and 3C illustrate an embodiment of a battery-powered sleeve in use with the fingerprint sensor installed on the smart card.

FIG. 4 is a diagram showing the smart card of FIG. 2 remotely powered by and in communication with a host device.

FIG. 5 is a diagram showing an exemplary embodiment of a transaction system including a smart card and a host device.

FIG. 6 is a diagram showing the smart card of FIG. 1 making electrical contact with a host device.

FIG. 7 is a diagram showing an exemplary embodiment of a transaction system including a smart card and a host device.

FIG. 8 is a diagram showing an exemplary embodiment of a power system.

FIG. 9 is a diagram showing an exemplary embodiment of a power system.

FIGS. 10A and 10B are diagrams showing examples of wireless power coupling.

FIG. 11 is a flow chart describing an example of the operation of a method for card not present transaction authorization.

FIG. 12 is a call flow diagram illustrating an exemplary embodiment of a system and method for card not present authorized user identity verification and subsequent transaction authorization.

FIG. 13 is a flow chart describing an example of the operation of a method for card not present transaction authorization.

FIG. 14 is a flow chart describing an example of the operation of a method for card not present user authentication.

FIG. 15 is a functional block diagram of an apparatus for card not present transaction authorization.

FIG. 16 is a functional block diagram of an apparatus for card not present transaction authorization.

FIG. 17 is a functional block diagram of an apparatus for performing card not present user authentication.

### DETAILED DESCRIPTION

While aspects of the subject matter of the present application may be embodied in a variety of forms, the following description and accompanying drawings are merely intended to disclose some of these forms as specific examples of the subject matter. Accordingly, the subject matter of this application is not intended to be limited to the forms or embodiments so described and illustrated.

Unless defined otherwise, all terms of art, notations and other technical terms or terminology used herein have the same meaning as is commonly understood by one of ordinary skill in the art to which this application belongs. All patents, applications, published applications and other publications referred to herein are incorporated by reference in their entirety. If a definition set forth in this section is contrary to or otherwise inconsistent with a definition set forth in the patents, applications, published applications, and other publications that are herein incorporated by reference, the definition set forth in this section prevails over the definition that is incorporated herein by reference.

Unless otherwise indicated or the context suggests otherwise, as used herein, “a” or “an” means “at least one” or “one or more.”

This description may use relative spatial and/or orientation terms in describing the position and/or orientation of a component, apparatus, location, feature, or a portion thereof. Unless specifically stated, or otherwise dictated by the context of the description, such terms, including, without limitation, top, bottom, above, below, under, on top of, upper, lower, left of, right of, in front of, behind, next to, adjacent, between, horizontal, vertical, diagonal, longitudinal, transverse, radial, axial, etc., are used for convenience in referring to such component, apparatus, location, feature, or a portion thereof in the drawings and are not intended to be limiting.

Furthermore, unless otherwise stated, any specific dimensions mentioned in this description are merely representative of an exemplary implementation of a device embodying aspects of the application and are not intended to be limiting.

As used herein, the term “adjacent” refers to being near or adjoining. Adjacent objects can be spaced apart from one another or can be in actual or direct contact with one another. In some instances, adjacent objects can be coupled to one another or can be formed integrally with one another.

As used herein, the terms “substantially” and “substantial” refer to a considerable degree or extent. When used in conjunction with, for example, an event, circumstance, characteristic, or property, the terms can refer to instances in which the event, circumstance, characteristic, or property occurs precisely as well as instances in which the event, circumstance, characteristic, or property occurs to a close approximation, such as accounting for typical tolerance levels or variability of the embodiments described herein.

As used herein, the terms “optional” and “optionally” mean that the subsequently described, component, structure, element, event, circumstance, characteristic, property, etc. may or may not be included or occur and that the description includes instances where the component, structure, element, event, circumstance, characteristic, property, etc. is included or occurs and instances in which it is not or does not.

It is common to see biometric sensors, such as, for example, fingerprint sensors, or other biometric sensors configured to capture one or more of image data, audio data, ultrasonic data, electric field data, and other data installed on human interface devices such as smartphones, laptops, pads, or other devices. For example, a fingerprint sensor installed on a smart phone can be used to verify the identity of the user. The fingerprint sensor can also be used as a data entry or a control mechanism for the smart phone. For example, the fingerprint sensor can detect the presence of a single finger touch and be programmed to activate a smart phone function or application upon detection.

As fingerprint sensors are gaining in implementation and user acceptance, fingerprint sensors are now finding use in numerous other devices such as, for example, smart cards, fitness monitors or trackers, wearable devices, domestic and industrial appliances, automotive components, and internet of things (IOT) devices. Some devices, such as smart cards and IOT devices, have limited or no user interfaces or status indicators such as screens, speakers, light emitting diodes (LEDs), and audio signals with which the device may impart information to the user. Such devices may also have limited or no user input mechanisms for receiving user input due to lack of a keyboard, switches, buttons, and levers.

Such devices, as well as computers, smart phones and the like are at times generally referred to in this application as “host devices.” A host device, such as a smart phone, an enrollment sleeve, or another device, may also be capable of providing power to and securely communicating with a smart card. For example, a host device such as a smart phone may be configured to use near field communications (NFC) technology to provide temporary power to and to securely communication with a smart card. Alternatively, a host device such as an enrollment sleeve may be configured to use a contact-based or non-contact based technology to provide temporary power to and securely communicate with a smart card.

Accordingly, there is a use for a fingerprint sensor installed on a device with limited ability to provide feedback to or obtain instructions from a user (hereinafter referred to as “limited device”) wherein the fingerprint sensor provides a data entry or a control mechanism for the device. The fingerprint sensor may have a prime purpose of verifying the user's identity, but can also function as convenient way to control functions performed in the limited device. In an exemplary embodiment, the fingerprint sensor may also be used to aid in user identification or authentication and transaction authorization in a CNP transaction.

In order for a biometric sensor, such as, for example, a fingerprint sensor, to function as a user verification device, a sufficiently detailed template (or multiple templates) of a user's biometric data (e.g., fingerprint) is captured and stored during an enrollment process, as known to those having ordinary skill in the art. The stored template (i.e., a verification template of biometric (e.g., fingerprint) data) is used to compare with biometric image data generated by the biometric sensor (e.g., an image of a finger, or one or more portions of a finger, sensed by the fingerprint sensor, sometimes referred to as a “live sensed image”, a “live fingerprint sample”, a “live image sample” or a “live image”) when the device is in subsequent general use, as known to those having ordinary skill in the art. In an embodiment employing a fingerprint sensor as the biometric sensor, a user is permitted to access a device if the live sensed image of the finger matches the stored fingerprint template. Accordingly, it is desirable to acquire and store a fingerprint template of sufficient scope and quality. If the stored fingerprint template is not of sufficient scope and quality, the user may experience false acceptance or rejection at an unacceptable rate.

While concepts described herein are applicable to various biometric sensors and associated biometric data and verification templates of biometric data, for purposes of illustration, and not for limitation, examples are frequently described herein in the context of fingerprint sensors and fingerprint data (i.e., images).

Typically, the fingerprint sensor used for the enrollment process has a sensing area smaller than the edge to edge surface of an average finger, such that a viable verification template must be built up from multiple images to fully map the entire surface of the finger. Specifically, the user is directed to repeatedly present his or her finger on the sensing area of the fingerprint sensor until multiple images of sufficient scope, expanse, and quality are gathered to build a complete fingerprint verification template (also referred to as a verification template). However, a fingerprint sensor installed on the limited device poses difficulties throughout the enrollment process. For example, the limited feedback/input capabilities make it difficult to notify the user: (i) to begin the enrollment process, (ii) to repeatedly present his or her finger during the enrollment process, (iii) that a sufficient number of contiguous images have been gathered, and (iv) that the enrollment process is complete. An enrollment process is described in commonly-owned U.S. Patent Application Publication No. 2020/0311509, entitled “Secure, Remote Biometric Enrollment”, the entire content of which is hereby incorporated into this document by reference in its entirety as if set forth fully herein.

In the context of the present application, a “sensor element” comprises an arrangement of one or more components configured to produce a signal based on a measurable parameter (e.g., capacitance, light/optics, heat/thermal, pressure, etc.), characteristics of which will vary based on the presence or absence of an object that is in local proximity to the sensor element. A capacitive fingerprint sensor will comprise an array of such sensor elements configured to produce an electrical signal proportional to the impedance of the surface of a finger placed on or near the fingerprint sensor. The sensitivity of each of the sensor elements of the fingerprint sensor is such that characteristics of the signal produced at each sensor element will vary based on surface characteristics, such as ridge patterns of the portion of finger placed on or near the array, and the varying characteristics of signals produced at each sensor element may be combined or otherwise processed to form a data file with an actual or virtual “image” of the fingerprint of the portion of the finger surface placed on or near the array. Specific examples of such sensor elements may include, but are not restricted to, capacitive, ultrasonic, optical, thermal, and pressure sensor elements.

In addition, sensor elements contemplated herein include both silicon-based sensors in which sensor elements are formed directly on a silicon semiconductor substrate and may form a 2-dimensional array of sensing pixels and off-silicon sensors in which sensor elements are not disposed directly on a silicon semiconductor substrate (e.g., so-called off-chip sensors) but formed on a non-silicon substrate and are conductively connected to a remotely-located control element, which may be a silicon-based semiconductor chip, such as an application specific integrated circuit (ASIC).

While aspects of this application are presented in the context of specific types of sensor elements and fingerprint sensor configurations, it should be appreciated that implementations of those aspects are not necessarily limited to a specific type of sensor elements of fingerprint sensors described herein.

As used herein, the term “identity authentication” refers to confirming the identity of an individual (a user) involved in a transaction, particularly, a CNP transaction. Identity authentication generally refers to verifying in real time that a person is who they claim to be for a transaction.

As used herein, the term “verification” refers to positive correlation resulting from the comparison of the verification template (having one or more previously obtained biometric features), created during enrollment, with a live image (having one or more current biometric features), also known as a live-captured sensor observation. A verification template typically identifies many distinctive features that can be used for correlation with a live fingerprint image, while the live-captured sensor observation of the live fingerprint image may only have a few distinctive features. When a particular correlation threshold between the verification template and the live fingerprint image is achieved, the observation is considered a positive verification and an authorization signal is generated indicating that the user's identity is authenticated.

As used herein, the term “transaction authorization” refers to a process of determining whether to approve a transaction, particularly, a CNP transaction. Transaction authorization generally refers to a collection of signals (or data) that can be used to minimize (or in some cases eliminate) the risk of fraud for a transaction.

The increasing number of digital transactions has resulted in new requirements for risk management and fraud prevention. Limits on the value of transactions due to risk management e.g., restricting transaction amounts, have been instituted to curb the losses incurred by merchants, transaction processors and consumers. Reducing these risks will allow higher limit valid transactions to proceed more expeditiously, reduce the number of fraudulent transactions, and provide a better experience for the merchant and for the consumer.

Currently, multiple mechanisms are in place to mitigate transaction fraud. Verification (or authentication) that the authorized user of a card is the same person actually using the card for a particular transaction is a very valuable and useful indicator of transaction integrity. The process of comparing a known biometric feature, such as a previously collected, verified and stored fingerprint of a user, to a newly collected biometric feature (such as a newly scanned fingerprint) and verifying a probabilistic match between the two is one form of biometric authentication.

Biometric authentication has been often utilized using simple human readable identifiers that are largely unique to the user, for example comparing signatures or driver's license photographs of the individual. Digital transactions, in particular on-line transactions, neither have the benefit of a retailer being face to face with a consumer nor the ability to directly examine proof of identity documents.

The capability to quickly compare a new or recently acquired biometric sample with a known good sample is becoming increasingly accurate and less costly. For example, fingerprint sensors, facial recognition technology and other biometric modalities are becoming easier and less costly to implement. Consumers have become comfortable with the ease-of-use and the high level of security that consumer biometrics provide, and new standards for use and deployment have been and continue to be widely disseminated. For example, the National Institute of Standards and Technology (NIST) is actively supporting biometric modalities and encouraging their safe use and is developing standards to help normalize the use of biometric modalities for identity verification and authentication.

During a transaction authorization process, a transaction processor will collect a number of data related to a transaction, which may include a biometric authentication or verification of a user's identity, and will make a real-time decision regarding the risk of a particular transaction. Other data collected may include geographic location, user's telephone number, user's IP address, etc. All these data are examined collectively in order to make a decision on whether to provide authorization for the transaction requested.

### Biometric Identity Authentication or Verification

There are currently a number of ways to verify that a person is who they claim to be; for example, comparing a feature that is unique to a person to a pre-existing version of that feature that may be subject to counterfeit. For example, matching a newly generated signature to a signature on file is one traditional way of verifying a person's identity, but it is subject to forgery. As another example, matching a person's face to a photograph on their official identification card is another well accepted form of biometric identity authentication, but has become significantly more difficult to do in a COVID world where facemasks and face coverings are commonly used. These matching techniques (identity verification and authentication techniques) are useful, but these tests can be circumvented.

An individual's fingerprint is a unique biometric identifier (or feature) of that individual without being impacted by coverings such as those now being globally used to cover the face. For example, fingerprints have been used by law enforcement and immigration authorities for some time, but the expense of collecting, archiving and matching fingerprints have traditionally been costly and impractical. Digital technologies have simplified the capture of an image of a fingerprint. For example, an image of a fingerprint can be captured, encoded and stored electronically so that key identification features of the individual can be associated with this particular fingerprint image. Then a new fingerprint (image, sample) can be captured, and compared with the previously stored fingerprint image and a statistical estimate can be made corresponding to the likelihood that the new fingerprint is a sufficient match with the previously collected fingerprint sample(s).

A fingerprint is one of many modalities that may be useful for biometric authentication. Other biometric modalities exist, such as two dimensional (2D) and three dimensional (3D) facial recognition, palm recognition, iris recognition, gait recognition, voice recognition, etc. Different biometric modalities offer different experiences for the user and different metrics for confidence of a match. However, attempting to maintain the biometric identifier or feature as confidential is not practical.

### Biometric Smart Card

A modern smart card may incorporate a biometric sensor capable of obtaining, processing, analyzing, and storing a biometric sample. A biometric sensor, and processing circuitry on a modern smart card may be configured to operate on power provided to the smart card by an external power source, or by a power source on the smart card. For example, a contact-enabled smart card may obtain power from a reader terminal, an enrollment sleeve, or another power source. A non-contact enabled smart card may obtain power from a reader terminal, a smart phone, or another power source, via for example NFC technology.

### In Person Card-Present (CP) Transaction

An in-person, face-to-face transaction at a retailer typically uses a point of sale (POS) terminal, which may include swipe, chip, pin or touch type interactions between the card and the POS terminal to complete a transaction. The retailer may be asked to verify a signature, or a modern POS terminal may collect card information and securely create and send credentials to verify the card is not fraudulent or being misused. A POS terminal that supports chip cards provides power to the card when the card is inserted into the transaction terminal. A POS terminal that supports non-contact technology generally provides power to the card by generating a wireless field, for example using NFC, from which the card harvests its power.

An in-person card transaction (also referred to as a card present or CP transaction), for example at a retail shop, relies on the presence of both the individual making the transaction and the card. Using a POS terminal, the card is swiped, inserted or touched to initiate the transaction. Traditionally, when using a swipe-enabled card, the retailer compares a newly acquired signature with the user's signature already present on the card. This information is static and will produce the same information for every transaction of this type.

Modern POS terminals; however, use dynamic (or dynamically) encoded information to verify that the card is valid. In order for a card to be the source for the dynamic encoded information, power is applied to the card. For cards having a “chip” (a processor, logic, etc., typically referred to as a smart card), inserting the smart card into the POS terminal provides power. For touch (or non-contact) cards the POS terminal transmits a radio signal from which the touch card may harvest power. Swipe cards do not have the capability of having power applied and therefore cannot create the dynamic encoded information that may be used for transaction validation.

Transaction fraud emanating from card-present transactions has been declining as magnetic swipe cards and swipe-only terminals have been upgraded to incorporate more secure modem chip and pin enabled technology. Unfortunately, in response, fraud perpetrators have shifted their focus to online transactions and because of this the fraud rates from CNP transactions have been steadily on the increase.

### On-Line Card Not Present (CNP) Transaction

In a current CNP transaction, a user typically provides, to a web site or mobile application, their credit card number (to identify the account), the expiration date, and the static CVV code, all of which are printed on the card in human readable form. Often, the retailer will redirect the user to a transaction processor to collect the information, process the transaction, and provide verification to the retailer and to the user that the transaction is authorized. Some retailers have also implemented what is referred to as a “card on file” mechanism to simplify the user experience. When directed, the retailer uses previously collected user information to create a new transaction. Retailers or transaction processors may also use what may be referred to as “out-of-band” information to develop a transaction decision. A limitation is that these systems do not accommodate dynamic information as part of the transaction authorization process, they only use the information printed in human readable form on the card to validate a transaction.

In order to complete a transaction for a CNP on-line transaction the user provides information from the card. This information often includes the account number, the static CVV code printed on the card, the expiration date printed on the card and the user's billing address or part of the user's billing address. There is no dynamically generated information to verify in real time that the card is actually in the possession of the authorized user, or that this particular user is authorized to use this card.

On-line retailers often use a transaction processor service to collect user transaction information, provide an assessment of risk for this transaction and engage with the user's and retailer's banks to facilitate transfer of funds. Transaction processors typically use a variety of data to make a fraud assessment and make a transaction authorization or denial.

As mentioned herein, some retailers implement a card-on-file mechanism in which they securely maintain the user's credentials and apply those credentials at checkout. These mechanisms provide convenience for the user, but do not add any increased scrutiny for fraud prevention because they are use the same static information present in human readable form on the card.

A transaction processor may use other out-of-band information to help verify a user and authorize a transaction. For example, geographic information gleaned from an IP address may indicate that a user is located in an unusual location. Other ways of mitigating risk include SMS or emailed verification codes that may be sent to the user, but these have inherent risks as well.

Given that all the aforementioned information is static and can be stolen or duplicated a significant drawback of an existing CNP transaction is the lack of dynamic (dynamically) encoded information which the transaction processor can use as a real time way to uniquely verify the identity of the user on a per transaction basis.

In an exemplary embodiment, a biometric sensor input can be used as one of a number of inputs to control the generation of a limited use, temporary use, or one-time use temporary passcode (such as a one-time PIN (OTP) code, a DCVV code, or another code) to uniquely authenticate a user of a credit card and authorize a transaction. Prior solutions typically have used an on-card Real Time Clock (RTC) chip, or circuit, along with the encrypted information stored on the smart card's secure element (SE) to create such a one-time use code. Such a one-time use code can be authenticated independently by a card issuer and can be used as an additional security measure to verify a transaction, particularly in a CNP transaction. A drawback of this prior solution is that it is costly to mass produce and typically includes a costly ultra-thin battery embedded on the smart card to keep the RTC chip, or circuit, continuously powered. Therefore, in some instances where it may be impractical to include a battery on a smart card, an alternative way of generating a one-time use code is desired.

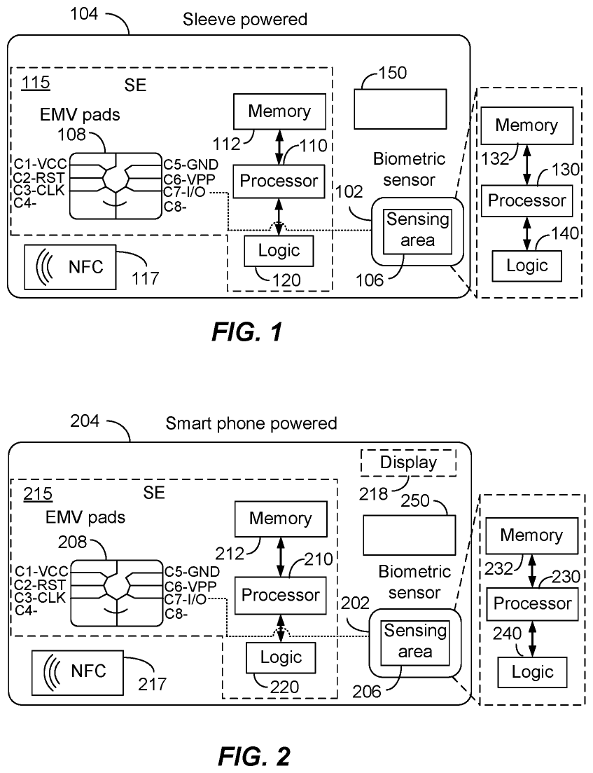

FIG. 1 illustrates a biometric sensor assembly or a biometric sensor, such as fingerprint sensor 102, installed on a smart card 104 according to some embodiments. In the illustrated embodiment shown in FIG. 1, the smart card 104 is a limited device, as described above, and the smart card 104 comprises the fingerprint sensor 102. In some embodiments, the smart card 104 comprises the fingerprint, or other biometric sensor 102, processor or processing circuitry 110, memory 112, logic 120 and contact pads 108 providing contacts for an external power source. In an exemplary embodiment, the fingerprint sensor 102 may also comprise processor or processing circuitry 130, memory 132 and logic 140. The contact pads 108 may be referred to as EMV (Europay, MasterCard, Visa) pads and may be used to provide a physical connection to a POS terminal, or other host device. The processing circuitry 110 and 130 may be a microprocessor, microcontroller, microcontroller unit (MCU), application-specific integrated circuit (ASIC), field-programmable gate array (FPGA), or any combination of components configured to perform and/or control the functions of the smart card 104. The memory 112 and 132 may be a read-only memory (ROM) such as EPROM or EEPROM, flash, or any other storage component capable of storing executory programs and information for use by the processing circuitry 110 and 130. The fingerprint sensor 102 may comprise sensor controlling circuitry and a sensor memory. The sensor controlling circuitry may be a microprocessor, microcontroller, application-specific integrated circuit (ASIC), field-programmable gate array (FPGA), or any combination of components configured to perform and/or control the functions of the fingerprint sensor 102. The sensor memory may be a read-only memory (ROM) such as EPROM or EEPROM, flash, or any other storage component capable of storing executory programs and information for use by the processing circuitry 110 and 130. The sensor controlling circuitry is configured to execute fingerprint sensor application programming (i.e., firmware) stored in the sensor memory. The memory 112 and the sensor memory 132 may be the same component. The sensor controlling circuitry is coupled to or may be part of the processing circuitry 110 and 130. The various components of the smart card 104 are appropriately coupled and the components may be used separately or in combination to perform the embodiments disclosed herein.

In an exemplary embodiment, the memory 112 may comprise logic 120 and the memory 132 may comprise logic 140. The logic 120 and 140 may comprise software, firmware, instructions, circuitry, or other devices, configured to be executed by the processing circuitry 110 and 130, respectively, to control one or more functions of the smart card 104, as described herein.

In an exemplary embodiment, the fingerprint sensor 102, the processor 110 and/or 130, the memory 112 and/or 132, and the logic 120 and/or the logic 140 may be configured to capture one or more current biometric features corresponding to a current user identity sample provided by a user, compare the one or more current biometric features to a previously obtained biometric feature corresponding to a previously obtained user identity sample, and if the one or more current biometric features matches the previously obtained biometric feature, generate an authorization signal that identifies the current user identity sample as belonging to an authorized user, the authorization signal corresponding to a user initiated successful biometric user authentication.

In an exemplary embodiment, the processor 110, the memory 112, and the logic 120 may be configured to access or generate a dynamically changing variable, such as, for example, a RTC output or value, or another numerical sequence.

In an exemplary embodiment, the smart card 104 may comprise a dynamically changing variable element 150 configured to generate or access a dynamically changing variable. In an exemplary embodiment, the dynamically changing variable element 150 may be located on the smart card 104 and may generate a dynamically changing variable locally on the smart card 104. In an exemplary embodiment, the dynamically changing variable element 150 may be powered by a persistent power source located on the smart card 104. In other embodiments, the dynamically changing variable element 150 may be code, logic, or executable code accessible to the processor 110 or processor 130 and be configured to provide access to a dynamically changing variable in embodiments where the smart card 104 does not include a persistent power source.

In an exemplary embodiment, the processor 110 and/or 130, the memory 112 and/or 132 and the logic 120 and/or the logic 140 may be configured to generate a temporary passcode for display on the host device. The temporary passcode may be used to authorize at least one transaction and may be generated from a combination of the authorization signal, fixed information previously stored securely on the card, and a dynamically changing variable (such as a RTC value or another dynamically changing variable that can be synchronized to). In some embodiments, the temporary passcode may be capable of being shared between a host device and the smart card.

In an exemplary embodiment, the temporary passcode may be displayed on a host device that may be temporarily coupled to the smart card 104 over, for example, a contact or a non-contact communication interface, such as a contact interface using the contact pads 108, or a non-contact interface, such as an NFC communication interface 117 or another interface.

In an exemplary embodiment, the fixed information previously stored securely on the card may comprise user specific private and/or confidential information that was previously captured and non-volatilely stored on the smart card 104 by the authorized user during a card initialization and user enrollment process and including information related to at least the previously obtained user identity sample, and individual private and/or confidential card specific information previously encrypted and non-volatilely stored on the smart card 104 during a card personalization process.

In an exemplary embodiment, the temporary passcode can be valid for a single or limited number of transactions, or can be valid for a short time window or for a preprogrammed time window.

In an exemplary embodiment, the user specific information that was previously captured and non-volatilely stored on the smart card 104 by an authorized user during a card initialization and user enrollment process comprises at least one biometric identifier of the authorized user.

In an exemplary embodiment, the individual card specific information previously encrypted and non-volatilely stored on the smart card 104 during a card personalization process comprises one or more of an account number representation, expiration date, CVV code, transaction counter and cryptographic keys programmed into the smart card during its manufacture.

In some embodiments, at least some of the authorization signal, the fixed information previously stored securely on the smart card 104, and the dynamically changing variable are encrypted.

In some embodiments, the authorization signal may have multiple states. For example, a state of the authorization signal may be an undetermined state prior to receiving the current user identity sample, a positive state where the current user identity sample matches the previously obtained user identity sample, and a negative state where the current user identity sample does not match the previously obtained user identity sample.

The contact pads 108 comprise one or more power transmission contacts, which may connect electrical components of the smart card 104, such as an LED, the processing circuitry 110, memory 112, sensor elements (e.g., the fingerprint sensor 102) etc., to an external power source. In some embodiments, the contact pads 108 further comprise one or more data transmission contacts that are distinct from the power transmission contacts which connect the smart card 104 to an external device configured to receive data from and/or transmit data to the smart card 104. In this context, the data transmission contacts of the smart card 104 are the contacts that convey data transmitted to or transmitted from the smart card 104.

The processing circuitry 110, the memory 112 and the logic 120 may comprise a secure element 115. The contact pads 108 may be part of the secure element 115 which includes the processing circuitry 110, memory 112, and logic 120, all of which are in electrical communication with the contact pads 108. In an exemplary embodiment, the secure element 115 may conform to an EMVCo. power management protocol commonly used on smart cards, and the contact pads 108 provide electric contacts between the smart card 104 and a host device, such as for example, a smart phone, an enrollment sleeve, a tablet computer, an external card reader, or other host device, to provide power to the processing circuitry 110 of the card and to read data from and/or write data to the memory 112. In an exemplary embodiment, a host device may provide temporary power to the smart card 104 using, for example, NFC technology, Qi power technology, a combination of NFC and Qi power technology, in which case the smart card 104 includes NFC element 117 or another power element (not shown).

In some embodiments, NFC capability may be implemented on the smart card 104 using NFC communication element 117 to communicate with a host device, and in some embodiments to allow a host device to provide power, or temporary power, to the smart card 104. NFC is a standards-based wireless communication technology that allows data to be exchanged between devices that are a few centimeters apart. NFC operates at 13.56 MHz and transfers data at up to 424 Kbits/seconds. In some embodiment, the NFC element 117 may be completely or partially part of, or contained within, the secure element 115.

When used for contactless transactions, NFC-enabled smart phones incorporate smart chips (called secure elements, similar to the secure element 115 on the smart card 104) that allow the smart phone to securely store and use the transaction application and consumer account information. Contactless transactions between an NFC-enabled mobile phone and a POS terminal use the standard ISO/IEC 14443 communication protocol currently used by EMV contactless credit and debit chip cards. NFC-enabled smart phones and other devices can also be used for a wide variety of other applications including chip-enabled mobile marketing (e.g., coupons, loyalty programs and other marketing offers), identity and access, ticketing and gaming. NFC is available as standard functionality in many mobile phones and allows consumers to perform safe contactless transactions, access digital content, and connect electronic devices simply. An NFC chip in a mobile device can act as a card or a reader or both, enabling consumer devices to share information and to make secure payments quickly.

In FIG. 1, contact pads 108 embody an exemplary smart card contact arrangement, known as a pinout. In an exemplary embodiment, contact C1, VCC, connects to a power supply. contact C2, RST, connects to a device to receive a reset signal, used to reset the card's communications. Contact C3, CLK, connects to a device to receive a clock signal, from which data communications timing is derived. Contact C5, GND, connects to a ground (reference voltage). In various embodiments, contact C6, VPP, may, according to ISO/IEC 7816-3:1997, be designated as a programming voltage, such as an input for a higher voltage to program persistent memory (e.g., EEPROM). In other embodiments, contact C6, VPP, may, according to ISO/IEC 7816-3:2006, be designated as SPU, for either standard or proprietary use, as input and/or output. Contact C7, I/O, provides Serial input and output (half-duplex). Contacts C4 and C8, the two remaining contacts, are AUX1 and AUX2 respectively and used for USB interfaces and other uses. In an exemplary embodiment, the fingerprint sensor 102 may communicate with the SE 115 using serial input and output capabilities of the SE 115. In some embodiments the fingerprint sensor 102 may be directly connected to contact C7.

In some embodiments described herein, the contact pads 108 are only used for providing connection points via the one or more power transmission contacts, such as C1 VCC and C5 GND, to an external power source, and no data is transmitted to or from the smart card 104 during an activation or enrollment process. The smart card 104 may comprise one or more power transmission contacts for connecting the smart card 104 to a power source, without any further data transmission capability as in a secure element. In other embodiments, the location of the fingerprint sensor 102 may be embedded into any position on the smart card 104 such that the position of the fingerprint sensor 102 is substantially separated from the contact pads 108 and allows a user to place a finger on the fingerprint sensor 102.

A user can carry out various functions on the smart card 104 by placing a finger in various positions over a sensing area 106 of the fingerprint sensor 102. The sensing area 106 comprises a two-dimensional array of sensor elements. Each sensor element is a discrete sensing component which may be enabled depending on the function of the fingerprint sensor 102. Any combination of sensor elements in the two-dimensional array may be enabled depending on the function of the fingerprint sensor. While the illustrated embodiment shown in FIG. 1 describes the fingerprint sensor 102 in relation to the smart card 104, this is not required and the fingerprint sensor 102, or other biometric sensor, may be incorporated in a different limited device in other embodiments. For example, other limited devices in which aspects of the technology describe herein may be incorporated include fitness monitors, wearable devices, domestic and industrial appliances, automotive components, and “internet of things” (JOT) devices.

In some embodiments, the sensing area 106 can have different shapes including, but not limited to, a rectangle, a circle, an oval, a diamond, a rhombus, or a lozenge.

The fingerprint sensor 102 may comprise an array of sensor elements comprising a plurality of conductive drive lines and overlapped conductive pickup lines that are separated from the drive lines by a dielectric layer. Each drive line may thus be capacitively coupled to an overlapping pickup line through a dielectric layer. In such embodiments, the pickup lines can form one axis (e.g., X-axis) of the array, while the drive lines form another axis (e.g., Y-axis) of the array. Each location where a drive line and a pickup line overlap may form an impedance-sensitive electrode pair whereby the overlapping portions of the drive and pickup lines form opposed plates of a capacitor separated by a dielectric layer or layers. This impedance-sensitive electrode pair may be treated as a pixel (e.g., an X-Y coordinate) at which a surface feature of the proximally located object is detected. The array or grid forms a plurality of pixels that can collectively create a map of the surface features of the proximally located object. For instance, the sensor elements forming the pixels of the grid produce signals having variations corresponding to features of a fingerprint disposed over the particular sensor element and thus the pixels along with circuitry controlling the sensor elements and processing signals produced by the sensor elements that includes a processor and signal conditioning elements (i.e., “sensor controlling circuitry”) that may be incorporated into an integrated circuit can map locations where there are ridge and valley features of the finger surface touching the sensor array.

Additional details of a fingerprint sensor with overlapping drive lines and pickup lines as well as the drive, sense, and scanning electronics, are discussed in U.S. Pat. No. 8,421,890, entitled “Electronic imager using an impedance sensor grid array and method of making,” U.S. Pat. No. 8,866,347, entitled “Biometric sensing”, and U.S. Pat. No. 9,779,280, entitled “Fingerprint Sensor Employing an Integrated Noise Rejection Structure,” the respective applications of which are hereby incorporated into this document by reference in their entirety as if set forth fully herein. Further improvements and enhancements to the devices, methods, and circuitry used to improve the sensitivity of the measurement principal employing a sensor grid comprised of overlapping drive lines and pickup lines separated by a dielectric including the drive, sense, scanning, and noise reduction electronics, are described in U.S. Pat. No. 9,779,280.

An exemplary installation of a fingerprint sensor in a smart card is described in U.S. Pat. No. 9,122,901, the application of which is hereby incorporated into this document by reference in its entirety as if set forth fully herein.

The sensing area 106 of the biometric sensor, (e.g., fingerprint sensor 102) installed on the smart card 104 may be selectively configured to operate in typically, but not limited to, five modes: (1) enrollment mode; (2) verification mode; (3) data input mode; (4) control mode; and (5) unlock mode. The user may select the different modes by different interactions with the sensor, such as a double tap, hold, up/down drag, and left/right drag on the sensor area 106. In other embodiments, the sensor 102 may be selectively configured in different modes by placing a data input device over the sensing area 106. Data input devices configured for different sensor operation modes may include unique detectable features that, when detected by the sensor, will configure the sensor in a mode corresponding to the data input device.

In the context of this application, a “data input device” is any device that may be attached or otherwise coupled to a host device and is thereby coupled to a biometric sensor of the host device to enable a user to provide inputs to the host device through the biometric sensor via features of the data input device that allow the user to interface with the biometric sensor to provide control inputs or inputs of data in addition to the particular biometric data that the biometric sensor is configured to detect. For instance, in examples described herein, the data input device includes keys or buttons that are each uniquely coupled to a fingerprint sensor of the host device so that a user contacting any such key or button generates a unique control input or a unique data input corresponding to that key or button. In addition, in other examples described herein, the attachment or coupling of the data input device to the host device, or its removal, may itself provide data input to the host device, for example, communicating that the data input device has been attached or coupled to, or removed from, the host device, that the data input device has or has not been properly positioned with respect to the biometric sensor to enable proper control or data input by the user, or, as described above, to place the biometric sensor in one of a number of operating modes.

In some embodiments, when the fingerprint sensor 102 is in enrollment mode, all of the sensor elements in the two dimensional array of the sensing area 106 are activated in a fingerprint sensing mode to produce signals—such as capacitance—having detectible variations corresponding to fingerprint features—grooves and ridges—in detective proximity to the sensor array (i.e., in physical contact with the sensor elements or in sufficient proximity to the sensor elements to produce signals corresponding to fingerprint features) which together form an “image” of the fingerprint, and the sensor controlling circuitry is configured so that multiple images of a user's fingerprint may be gathered, and, possibly, manipulated, to acquire a sufficient fingerprint template that may be subsequently stored in memory. An exemplary enrollment process is described in U.S. Pat. No. 9,684,813, entitled “System and Method of Biometric Enrollment and Verification,” the application of which is hereby incorporated into this document by reference in its entirety as if set forth fully herein. The stored fingerprint template may be continuously updated based on the user's use of the fingerprint sensor over time.

In some embodiments, when the fingerprint sensor 102 is in verification mode (also known as authentication mode), all of the sensor elements in the sensing area 106 are activated in fingerprint sensing mode and the sensor controlling circuitry is configured so that an image of the user's fingerprint may be acquired and compared with the fingerprint template stored in memory to verify that the acquired fingerprint image sufficiently matches the fingerprint template. An exemplary verification process is also described in U.S. Pat. No. 9,684,813. An exemplary verification process is also described in U.S. patent application Publication No. U.S. 2018/0144173 entitled “Combination of Fingerprint and Device Orientation to Enhance Security,” the application of which is hereby incorporated into this document by reference in their entirety as if set forth fully herein. Ideally, in both the enrollment mode and the verification mode, a finger should be placed centrally on the sensing area 106 of the fingerprint sensor 102 in order to obtain the best image of the finger.

In some embodiments, when the fingerprint sensor 102 is in control mode and data input mode, the sensor elements in the sensing area 106 are activated in contact sensing mode, data input keys are operatively coupled to associated spatially distinct regions or control areas of the sensing area to enable direct or indirect contact by a user's finger with each associated spatially distinct area, and the sensor controlling circuitry is configured so that the user may input data through the sensing area 106 by directly or indirectly placing a finger on selected, associated spatially distinct control areas within the sensing area 106 of the fingerprint sensor 102. That is, as opposed to the enrollment and verification modes in which the sensor elements and the processor of the sensor controlling circuitry are configured to detect and map different fingerprint features of the finger surface in contact sensing mode for the control and data input modes, the sensor elements and the sensor controlling circuitry may be configured to merely detect whether or not the sensor element is directly or indirectly contacted by a finger surface and to distinguish a spatially distinct region of the sensor array in which the contacted element(s) reside.

In both the control mode and the data input mode, the sensing area 106 may be divided into spatially distinct control areas dedicated to a specific command or data input. The number and location of the spatially distinct control areas within the sensing area 106 may be configured depending on the desired use of the fingerprint sensor 102, the size of the sensing area 106, and the ability of the fingerprint sensor 102 to accurately distinguish contact by the finger with the different spatially distinct regions on the sensor. In unlock mode, the smart card 104 may remain in data input mode until the user inputs a correct unlock code, wherein the input of the correct code unlocks the smart card 104.

In some embodiments described herein, when the fingerprint sensor is in control mode and data input mode, a first portion of the sensor elements in the sensing area 106 are activated in contact sensing mode, data input keys are operatively coupled to associated spatially distinct regions or control areas of the first portion of the sensing area to enable direct or indirect contact by a user's finger with each associated spatially distinct area, and the sensor controlling circuitry is configured so that the user may input data through the sensing area 106 by directly or indirectly placing a finger on selected, associated spatially distinct control areas within the first portion of the sensing area 106 of the fingerprint sensor 102. In such embodiments, when the fingerprint sensor is in enrollment mode, only the sensor elements located within a second portion of the two-dimensional array of the sensing area 106 different from the first portion and accessible to a user's finger may be activated in the fingerprint sensing mode and the sensor controlling circuitry is configured so that multiple images of a user's fingerprint may be gathered to acquire a sufficient fingerprint template that is stored in memory.

FIG. 2 illustrates an alternative exemplary embodiment of a biometric sensor assembly or a biometric sensor, such as fingerprint sensor 202, installed on a smart card 204 according to some embodiments. The smart card 204 is similar to the smart card 104 described in FIG. 1, and the description of some of the elements of FIG. 2 may be abbreviated where similar elements have been described in FIG. 1. Some elements in FIG. 2 that are similar to corresponding elements in FIG. 1 are numbered using the nomenclature 2XX, where an element in FIG. 2 labeled 2XX is similar to a corresponding element in FIG. 1 labeled 1XX.

In the exemplary embodiment shown in FIG. 2, the smart card 204 is similar to the smart card 104 (FIG. 1) and as such is a limited device, as described above. In this exemplary embodiment, the smart card 204 comprises the fingerprint sensor 202. In some embodiments, the smart card 204 comprises the fingerprint, or other biometric, sensor 202, processor or processing circuitry 210, memory 212, a display 218, an NFC element 217, and contact pads 208 providing contacts for an external power source and/or other connections. In an exemplary embodiment, the fingerprint sensor 202 may also comprise processor or processing circuitry 230, memory 232 and logic 240, as described regarding the fingerprint sensor 102 of FIG. 1. The contact pads 208 may be EMV pads as described above. The processing circuitry 210 and 230 may be a microprocessor, MCU, application-specific integrated circuit (ASIC), field-programmable gate array (FPGA), or any combination of components configured to perform and/or control the functions of the smart card 204. The memory 212 and the memory 232 may be a read-only memory (ROM) such as EPROM or EEPROM, flash, or any other storage component capable of storing executory programs and information for use by the processing circuitry 210 and 230. The sensor controlling circuitry, processing circuitry 230, may be a microprocessor, microcontroller, application-specific integrated circuit (ASIC), field-programmable gate array (FPGA), or any combination of components configured to perform and/or control the functions of the fingerprint sensor 202. The sensor memory 232 may be a read-only memory (ROM) such as EPROM or EEPROM, flash, or any other storage component capable of storing executory programs and information for use by the processing circuitry 210 and 230. The sensor controlling circuitry is configured to execute fingerprint sensor application programming (i.e., firmware), such as logic 240 that may be stored in the sensor memory. The memory 212 and the sensor memory 232 may be the same component. The sensor controlling circuitry is coupled to or may be part of the processing circuitry 210.

In an exemplary embodiment, the memory 212 may comprise logic 220 and the memory 232 may comprise logic 240. The logic 220 and/or the logic 240 may comprise software, firmware, instructions, circuitry, or other devices, configured to be executed by the processing circuitry 210 or 230 to control one or more functions of the smart card 204.

In an exemplary embodiment, the fingerprint sensor 202, the processor 210 and/or 230, the memory 212 and/or 232, and the logic 220 and/or the logic 240 may be configured to capture one or more current biometric features corresponding to a current user identity sample provided by a user, compare the one or more current biometric features to a previously obtained biometric feature corresponding to a previously obtained user identity sample, and if the one or more current biometric features matches the previously obtained biometric feature, generate an authorization signal that identifies the current user identity sample as belonging to an authorized user, the authorization signal corresponding to a user initiated successful biometric user authentication.

In an exemplary embodiment, the processor 210, the memory 212, and the logic 220 may be configured to access or generate a dynamically changing variable, such as, for example, a RTC output or value.

In an exemplary embodiment, the smart card 204 may comprise a dynamically changing variable element 250 configured to generate or access a dynamically changing variable. In an exemplary embodiment, the dynamically changing variable element 250 may be located on the smart card 204 and may generate a dynamically changing variable locally on the smart card 204. In an exemplary embodiment, the dynamically changing variable element 250 may be powered by a persistent power source located on the smart card 204. In other embodiments, the dynamically changing variable element 250 may be code, logic, or executable code accessible to the processor 210 or processor 230 and be configured to provide access to a dynamically changing variable in embodiments where the smart card 104 does not include a persistent power source.

In an exemplary embodiment, the processor 210 and/or 230, the memory 212 and/or 232 and the logic 220 and/or the logic 240 may be configured to generate a temporary passcode for display on the host device. The temporary passcode may be used to authorize at least one transaction and may be generated from a combination of the authorization signal, fixed information previously stored securely on the card, and a dynamically changing variable (such as a RTC output or value).

In an exemplary embodiment, the temporary passcode may be displayed on the display 218, or may be provided to a host device that may be temporarily coupled to the smart card 204 over, for example, an NFC communication interface or other interface.

The various components of the smart card 204 are appropriately coupled and the components may be used separately or in combination to perform the embodiments disclosed herein.

The contact pads 208 comprise one or more power transmission contacts, which may connect electrical components of the smart card 204, such as an LED, the processing circuitry 210, memory 212, NFC element 217, display 218, sensor elements (e.g., the fingerprint sensor 202) etc., to an external power source. In some embodiments, the contact pads 208 further comprise one or more data transmission contacts that are distinct from the power transmission contacts which connect the smart card 204 to an external device configured to receive data from and/or transmit data to the smart card 204. In this context, the data transmission contacts of the smart card 204 are the contacts that convey data transmitted to or transmitted from the smart card 204.

The processing circuitry 210, the memory 212 and the logic 220 may comprise a secure element 215. The contact pads 208 may be part of the secure element which includes the processing circuitry 210, memory 212, and the logic 220, all of which are in electrical communication with the contact pads 208. In some embodiments, the NFC element 217 may be included, or be part of, the secure element 215. In an exemplary embodiment, the secure element 215 may conform to the EMVCo. power management protocol commonly used on smart cards, and the contact pads 208 provide electric contacts between the smart card 204 and a host device, such as for example, a smart phone, a tablet computer, an external card reader, or another host device, to provide power to the processing circuitry 210 of the card and to read data from and/or write data to the memory 212. In an exemplary embodiment, a host device may provide temporary power to the smart card 204 using, for example, NFC technology.

In some embodiments, NFC capability may be implemented on the smart card 204 using NFC communication element 217 to communicate with a host device, and in some embodiments to allow a host device to provide power, or temporary power, to the smart card 204.

In FIG. 2, contact pads 208 are similar to the contact pads 108 of FIG. 1. In some embodiments described herein, the contact pads 208 are only used for providing connection points via the one or more power transmission contacts, such as C1 VCC and C5 GND, to an external power source, and no data is transmitted to or from the smart card 204 during an activation or enrollment process as described herein. The smart card 204 may comprise one or more power transmission contacts for connecting the smart card 204 to a power source, without any further data transmission capability as in a secure element. In an exemplary embodiment, the fingerprint sensor 202 may communicate with the SE 215 using serial input and output capabilities of the SE 215. In some embodiments the fingerprint sensor 202 may be directly connected to contact C7.

In other embodiments, the location of the fingerprint sensor 202 may be embedded into any position on the smart card 204 such that the position of the fingerprint sensor 202 is substantially separated from the contact pads 208 and allows a user to place a finger on the fingerprint sensor 202.

A user can carry out various functions on the smart card 204 by placing a finger in various positions over a sensing area 206 of the fingerprint sensor 202, as described above with respect to the fingerprint sensor 102 of FIG. 1.

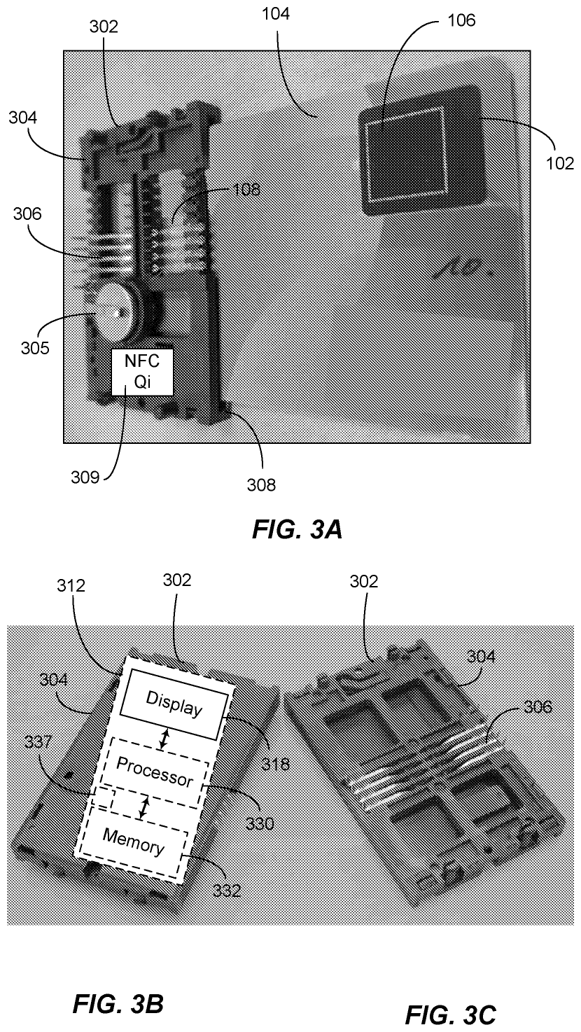

FIGS. 3A-3C illustrate an embodiment of a battery-powered sleeve 302 in use with the fingerprint sensor 102 installed on the smart card 104. In an exemplary embodiment, the sleeve 302 may also be referred to as a “slide on” or “plug in” sleeve. In some embodiments, the sleeve 302 is powered by a suitable battery 305, such as a small cell LR44, or another form factor compatible cell. Alternatively, the sleeve 302 may rely on any suitable power element, such as solar or harvested power, such as that generated by an NFC or Qi power circuit 309 or from an external power source or a wired power source such as a wall wart or other charger. In some exemplary embodiments, the sleeve 302 may also be referred to as a host device and/or a power source. In some exemplary embodiments, the sleeve 302 may be configured to provide temporary power to the smart card 104. The sleeve 302 may comprise a socket (not shown), such as a USB socket, to allow connection of the sleeve 302 to a main power source. As shown in FIG. 3A, the sleeve 302 may include a connector housing (or receptacle) 304 with a slot 308 configured to receive an end of the smart card 104 and contacts 306 (or terminals or electrodes, e.g., flexible conductive pins) within the housing 304 that are connected to the power element (e.g., battery 305) according to some embodiments. In some embodiments, the housing 304 is made of injection molded plastic and comprises a minimal number of parts. The housing 304 may be made of a transparent material such that the user may confirm that the sleeve 302 is used solely for the purpose of providing power to the smart card 104. The sleeve 302 is configured to be removably attached to a smart card by inserting the smart card 104 into the slot 308, and the contacts 306 within the housing may contact the power transmission contacts of the contact pads 108 (e.g., typically contacts C1 VCC and C5 GND of contact pads 108 of an EMVCo. power management compliant card of FIG. 1) to thereby electrically connect the smart card 104 to the power element 305 and provide power to the smart card 104 when inserted into the housing 304 of the sleeve 302. In an exemplary embodiment, eight contacts 306 are shown in FIGS. 3A, 3B and 3C corresponding to an exemplary pinout as shown in contact pads 108 of FIG. 1, but only two contacts 306 are used to connect the smart card 104 to the power transmission contacts when the smart card 104 is inserted into the housing 304 of the sleeve 302. The remaining contacts may be omitted if no data is to be transmitted to or from the smart card 104. Removing the smart card 104 from the housing 304 disconnects the smart card 104 from the power element 305 in the sleeve 302. The smart card 104 may only receive power from the sleeve 302 and does not need any additional external electrical connections or wireless connections in order to operate.

In some embodiments, the sleeve may comprise a processor 330, a memory 332, a display 318, and a dynamically changing variable element 337, which may be located on a printed circuit board (PCB) 312 located in the sleeve 302. In an exemplary embodiment, the contacts 306 may also be coupled to the PCB 312 and the PCB 312 may include electrical connections to provide the signals from the contacts 306 to other components on the PCB 312 or on the sleeve 302. In some embodiments, the display 318 may be configured to display to a user information that may be provided to the sleeve 302 by a smart card 104.

In an exemplary embodiment, the processor 330 and the memory 332 may be configured to access or generate a dynamically changing variable, such as, for example, a RTC output or value using the dynamically changing variable element 337 to provide the dynamically changing variable.

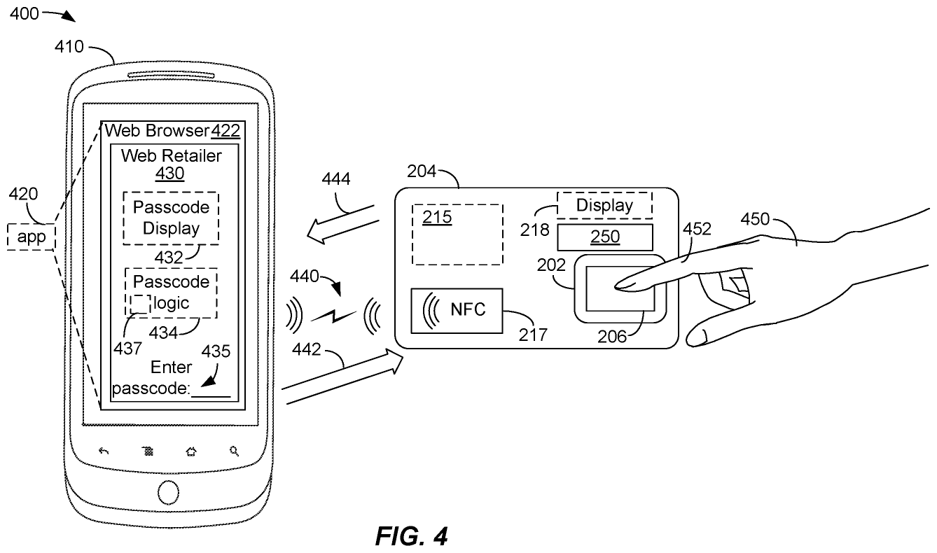

FIG. 4 is a diagram 400 showing the smart card 204 of FIG. 2 remotely powered by and in communication with a host device. In an exemplary embodiment, a host device may be a smart phone 410. In an exemplary embodiment, a smart phone 410 may be any smart phone capable of providing the functionality described herein. In an exemplary embodiment, the smart phone 410 may be configured with one or more applications (apps), with an exemplary app 420 shown for illustrative purposes only. In an exemplary embodiment, the app 420 may be configured to provide a web browser 422 on the smart phone 410. The web browser 422 may be configured to display one or more web pages, or web sites, with a web retailer 430 being shown for illustrative purposes. The app 420 may also include functionality in the form of passcode logic 434, a passcode display 432 and a passcode entry element (or field) 435.

In an exemplary embodiment, a communication interface 440 may be established between the smart phone 410 and the smart card 204. In an exemplary embodiment, the communication interface 440 may be a wireless interface, such as a NFC interface. In an exemplary embodiment, the communication interface 440 may also be configured to allow the smart phone 410 to provide temporary power to the smart card 204. In an exemplary embodiment, the communication interface 440 may be configured to allow the smart phone 410 to exchange information (data) with the smart card 204. In an exemplary embodiment, the communication interface 440 is used to provide communications from the smart phone 410 to the smart card 204 shown by arrow 442. In an exemplary embodiment, the communication interface 440 is used to provide communications from the smart card 204 to the smart phone 410 shown by arrow 444.

In an exemplary embodiment, a dynamically changing variable, such as value associated with a RTC, or another dynamically accessible or shareable variable, may be generated by or may be accessible by the smart phone 410, for example, using a dynamically changing variable element 437 in the passcode logic 434 to generate a dynamically changing variable. In an exemplary embodiment, the dynamically changing variable generated or accessed by the dynamically changing variable element 437 may be communicated from the smart phone 410 to the smart card 204 over communication interface shown by arrow 442. In an exemplary embodiment, the dynamically changing variable may act as a seed for an algorithm that can be used to encrypt the communications between the card and the host, and when combined with fixed information previously stored securely on the smart card 204, can also generate a card-generated temporary passcode. In an exemplary embodiment the card-generated temporary passcode may comprise a very large number that may be truncated to create a human-readable format for compatibility with legacy systems, or may be used in its entirety if human-readability is not required.

In an exemplary embodiment, the fixed information previously stored securely on the smart card 204 may have been provisioned on the smart card 204 by a card issuer when the card was issued in a secure environment. When a transaction is being authorized, a card issuer (or a transaction authorization system) executes the same (or substantially the same) algorithm (or instance of the algorithm) using a synchronized instance of the dynamically changing variable as the seed, along with the fixed information previously stored securely on the smart card 204 to generate an equivalent (or substantially equivalent) temporary passcode. In this manner, the dynamically changing variable generated or accessed by the smart phone 410 is synchronized with a corresponding dynamically changing variable generated or accessed by the card issuer (or a transaction authorization system) so that the temporary passcode generated by the smart phone 410 corresponds to the temporary passcode generated by the card issuer (or a transaction authorization system). The transaction authorization system compares the card-generated temporary passcode with the equivalent (or substantially equivalent) temporary passcode generated by the card issuer. If the card-generated temporary passcode and the equivalent temporary passcode generated by the card issuer (or a transaction authorization system) match, the transaction may proceed. If the card-generated temporary passcode does not match the equivalent temporary passcode, the transaction is denied. Examples of algorithms that may be used to generate the card-generated temporary passcode and the equivalent temporary passcode generated by the card issuer (or a transaction authorization system) include, for example only and without limitation, encryption algorithms such as hash functions, and symmetrical and asymmetrical key algorithms, for example, a time-based one time password (OTP) or a hash-based OTP. For example, a hash-based OTP delivers a sequence of numbers where both the card and the card issuer can generate the next number in the sequence. A time-based OTP is derived from a real time clock (RTC). Both time-based and hash-based algorithms use public-key cryptography to exchange either the hash data or the time-based code.

A user 450 is partially illustrated in FIG. 4. The user 450 may interact with the smart phone 410 and with the smart card 204. The smart card 204 is the smart card described in FIG. 2, with some detail omitted for ease of illustration. In an exemplary embodiment, the user 450 may apply a finger 452 to the sensing area 206 of the fingerprint sensor 202 for a number of different actions, one of which being to provide for capture one or more current biometric features, (such as a live fingerprint sample) corresponding to a current user identity sample. In an exemplary embodiment, the smart card 204 may be configured to compare the one or more current (or live) biometric features obtained from the user 450 to a previously obtained biometric feature corresponding to a verification template of a previously obtained user identity sample corresponding to the user 450.

In an exemplary embodiment, if the one or more current biometric features matches the previously obtained biometric feature, the smart card 204 may be configured to generate an authorization signal that identifies the current user identity sample as belonging to an authorized user, the authorization signal corresponding to a user initiated successful biometric user authentication.

In an exemplary embodiment, the smart card 204 may be configured to generate a temporary passcode (such as a DVCC). The temporary passcode may be displayed 218 on the smart card 204, or may be communicated over the communication interface 440 for display on the smart phone 410 by the passcode display 432. In an exemplary embodiment, the temporary passcode may be used to authorize at least one transaction and may be generated from a combination of the authorization signal, fixed information previously stored securely on the smart card 204, and the dynamically changing variable provided by the smart phone 410 to the smart card 204 in this example. In other exemplary embodiments, the dynamically changing variable may be generated or accessed by the smart card 204. In an exemplary embodiment, the temporary passcode is capable of being shared between the smart phone 410 and the smart card 204.

In an exemplary embodiment, the temporary passcode may be communicated to the smart phone 410 over the communication interface 440 and directly entered on the passcode entry element 435.

In an exemplary embodiment, the authorization signal may be communicated to the smart phone 410 over the communication interface 440 and the app 420 may be configured to use the passcode logic 434 to generate the temporary passcode. In an exemplary embodiment, the temporary passcode may be displayed by the host device 410 on the display 432. In an exemplary embodiment, the temporary passcode may be entered by the user 450 into the app 420 via the passcode entry element 435.

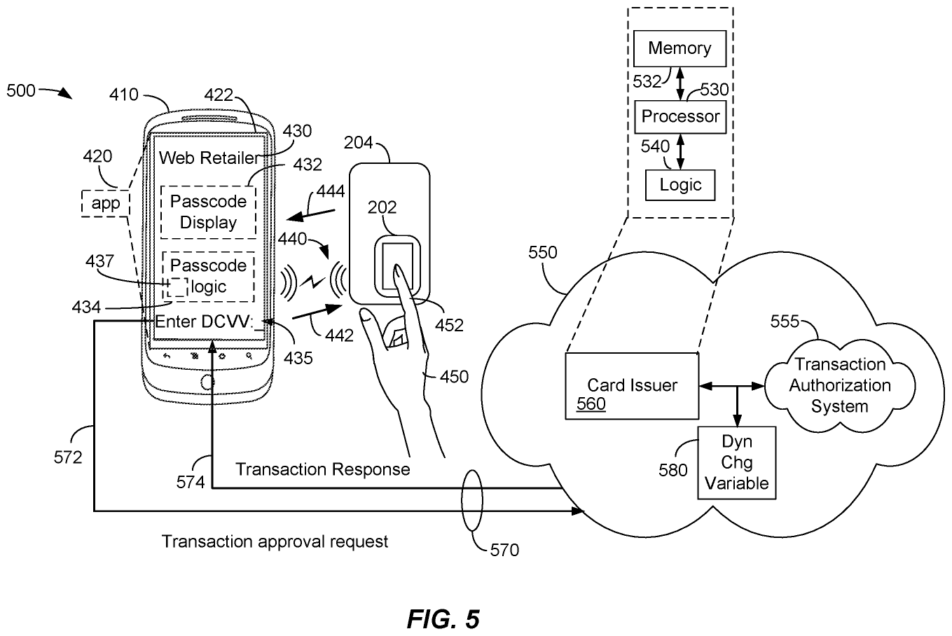

FIG. 5 is a diagram showing an exemplary embodiment of a transaction system 500 including a smart card and a host device. In an exemplary embodiment, the transaction system 500 may comprise the smart card 204 and the host device (the smart phone 410) of FIG. 4. Some elements in FIG. 5 that are similar to corresponding elements in FIG. 4 are numbered using the nomenclature 5XX, where an element in FIG. 5 labeled 5XX is similar to a corresponding element in FIG. 4 labeled 4XX.

In an exemplary embodiment, the transaction system 500 includes a smart phone 410 and a smart card 204 that may communicate over communication interface 440. In an exemplary embodiment, the smart phone 410 may supply temporary power to the smart card 204 over the communication interface 440. In some embodiments, the smart phone 410 and the smart card 204 may communicate unidirectionally or bidirectionally over communication interface 440, and may communicate securely or non-securely over communication interface 440.

In an exemplary embodiment, the smart phone 410 may also be in communication with a network 550. As used herein, the term “network” for the network 550 may comprise one or more distributed computing resources, entities, logic entities, etc. In an exemplary embodiment, the network 550 may include a card issuer 560 and a dynamically changing variable element 580. As used herein, a card issuer 560 may be an entity that creates, manages, oversees, personalizes, and maintains information, including personal and/or confidential information, related to smart cards and users of smart cards. In an exemplary embodiment, the card issuer 560 may also have the ability to create and store user information in a secure manner to the smart card 204 and to archivally store and retrieve user information to calculate the equivalent (or substantially equivalent) temporary passcode used to compare with the card-generated temporary passcode transmitted with a transaction request. The card issuer 560 may also have the ability to generate the equivalent temporary passcode (such as a DCVV) using the dynamically changing variable element 580, which may generate or have access to a dynamically changing variable (such as a RTC output or value or another dynamically changing variable) as a seed for the equivalent temporary passcode, and has the ability to authorize or deny a transaction, such as a financial transaction or other type of transaction. Among other processing capability, in an exemplary embodiment the card issuer 560 may comprise a processor or processing circuitry 530, memory 532 and logic 540, configured to generate the equivalent temporary passcode (such as a DCVV) using a dynamically changing variable (such as a RTC output or value or another dynamically changing variable) provided by or accessed by the dynamically changing variable element 580.

The network 550 may also comprise a transaction authorization system 555. In an exemplary embodiment, the card issuer 560 may comprise some or all of the transaction authorization system 555; however, in some embodiments, the transaction authorization system 555 may be a separate entity. In some embodiments, the transaction authorization system 555 may reside within the card issuer 560. In an exemplary embodiment, the dynamically changing variable is accessible in real time (or substantially simultaneously accessible) to or by both the smart card 204 (or the smart phone 410) and to the card issuer 560 (or to the transaction authorization system 555).

In an exemplary embodiment, the smart phone 410 may be in communication with the network 550 over a communication interface 570. In an exemplary embodiment, the communication interface 570 may be any communication interface or network that provided wired or wireless connectivity between the smart phone 410 and the network 550. In an exemplary embodiment, the network 550 may comprise wireless communication links, such as, for example, WiFi, Bluetooth, cellular, etc., and may comprise wired communication links, such as, for example, a LAN, a WAN, or other communication interface. In an exemplary embodiment, communication from the smart phone 410 to the network 550 may occur over a communication link 572 and may be referred to as “upstream” traffic; and communication from the network 550 to the smart phone 410 may occur over a communication link 574 and may be referred to as “downstream” traffic. In an exemplary embodiment, the communication interface 570 comprises both communication links 572 and 574. Further, while illustrated as single connections, the communication links 572 and 574 may comprise more than one connection, and may comprise wired and/or wireless communication links. Exemplary embodiments of information that may be communicated over the communication links 572 and 574 include, voice, data, etc., and in some embodiments, may include transaction information.

In an exemplary embodiment, a user 450 may initiate a transaction using the smart phone 410. For example, the user may open a web browser 422 and browse to a web retailer 430. The web retailer 430 may recognize that the web browser 422 on the smart phone 410 is connected and may respond with an acknowledgement. In an exemplary embodiment, the web retailer 430 may also establish communication with the card issuer 560. This communication may occur over the communication interface 570.

In an exemplary embodiment, the user 450 may attempt to purchase an item or service from the web retailer 430. Typically, such a transaction falls into the category of a CNP transaction because the user 450 is remote from the web retailer 430. In an exemplary embodiment, as part of the transaction request, the user 450 may provide some information to the web retailer 430, such as name, address, a credit card number, month and expiration of the credit card, and the CVV code typically printed on the back of a credit card, all of this information being static information may be available to any individual in possession of the smart card 204. However, in some embodiments, to provide additional security, it would be desirable to provide additional information relating to the identity of the user.

In order to make the CNP transaction as secure as possible, it would be desirable to include additional dynamic information to allow the user 450 to complete the transaction. For example, it would be desirable to provide a temporary passcode that may be associated with the user 450, where the temporary passcode can be used as at least one element of data that can be used to authorize the transaction.

For example, in response to the transaction request, the web retailer 430 may request dynamic information, such as a temporary passcode.

In an exemplary embodiment, if not already done so, the user 450 may couple the smart card 204 to the smart phone 410 so that the smart phone 410 may provide temporary power to the smart card 204. For example, the smart phone 410 may provide temporary power to the smart card 204 over the communication interface 440 using, for example, NFC technology, Qi power technology, or another technology for providing wireless power that the smart card 204 may harvest. In addition to providing temporary power to the smart card 204, in some embodiments, the smart phone 410 may also exchange other information with the smart card 204.

In an exemplary embodiment, the user 450 may present biometric information in the form of a biometric sample to the smart card 204. For example, the user 450 may present a finger 452 to the fingerprint sensor 202. In this example, the smart card 204 may capture one or more live biometric features corresponding to a current user 450 identity sample, such as a live fingerprint image.

In an exemplary embodiment, the smart card 204 may compare the one or more live biometric features to a previously obtained biometric feature corresponding to a previously obtained user identity sample stored on the card as a verification template, as described above.

If the one or more live biometric features match the previously obtained biometric feature, the smart card 204 may be configured to generate an authorization signal that identifies the current user identity sample as belonging to an authorized user. In an exemplary embodiment, the authorization signal corresponds to a user initiated successful biometric user authentication.

Once the user 450 is authenticated, the smart card may be configured to generate a temporary passcode. The card-generated temporary passcode may be displayed on the passcode display 432 on the smart phone 410. In an exemplary embodiment, the card-generated temporary passcode may be, for example, a DCVV code that the user 450 may enter using the passcode entry element 435 on the smart phone 410.

In an exemplary embodiment, the card-generated temporary passcode may be generated from a combination of the authorization signal, fixed information previously stored securely on the card, and a dynamically changing variable, the card-generated temporary passcode being capable of being shared between the host device (smart phone 410) and the smart card 204 in this example.

In an exemplary embodiment, the dynamically changing variable may be publicly known information that may act as a seed for an algorithm that may be used to generate the temporary passcode. In an exemplary embodiment, the dynamically changing variable may be accessed by, or generated by, the smart phone 410 using the dynamically changing variable element 437 or by the smart card 204 using the dynamically changing variable element 250. In an exemplary embodiment, the dynamically changing variable may comprise a RTC value (or may comprise or another dynamically changing variable or another numerical sequence that can be synchronized to) and may be communicated from the smart phone 410 to the smart card 204. In an exemplary embodiment, the dynamically changing variable changes from transaction to transaction, thereby allowing the temporary passcode to also change from transaction to transaction, thus improving transaction security. As an example of a dynamically changing variable, a RTC output or value is universally and simultaneously available to the card and/or to the host device, and to the card issuer for all transaction systems worldwide. Another example of a dynamically changing variable is a card transaction counter, which is updated on the card and by the card issuer after each transaction. The card issuer also independently and confidentially keeps track of the number of transactions. However, although a card transaction counter may be updated after each transaction, a drawback of using a card transaction counter as a dynamically changing variable as described herein is the synchronization requirement that the actual real time number of transactions be updated and be simultaneously available to all possible POS transaction points worldwide. This is in practice difficult to implement reliably on a large, distributed network. In addition, the existence of multiple familial cards with the same card number makes using a card transaction counter as a dynamically changing variable even more challenging.

In an exemplary embodiment, after the user enters the card-generated temporary passcode (such as a DVCC), a transaction approval request is sent from the web retailer 430 to the card issuer 560. For example, the transaction approval request may be sent over the communication link 572.

In an exemplary embodiment, the card issuer 560 receives the transaction approval request, and in an exemplary embodiment, the card issuer 560 uses the same (or substantially similar) algorithm (or instance of the algorithm) as the smart card 204 to independently generate the same (or a substantially equivalent) temporary passcode (such as a DCVV) using the dynamically changing variable as the seed, along with the fixed information previously stored securely on the smart card 204. The card issuer 560 (or the transaction authorization system 555) compares the card-generated temporary passcode sent over the communication link 572 (the transaction approval request) with the equivalent temporary passcode generated by the card issuer 560 (or the transaction authorization system 555).

If the equivalent temporary passcode matches the card-generated temporary passcode generated by the smart card 204, the card issuer 560 (and/or the transaction authorization system 555) proceeds to approve the transaction approval request. In an exemplary embodiment, the dynamically changing variable is accessible in real time (or substantially simultaneously accessible) to both the smart card 204 and the transaction authorization system 555.

In an exemplary embodiment, a transaction response is sent from the card issuer 560 to the web retailer 430. For example, the transaction response, whether an approval or a denial, may be sent over the communication link 574.

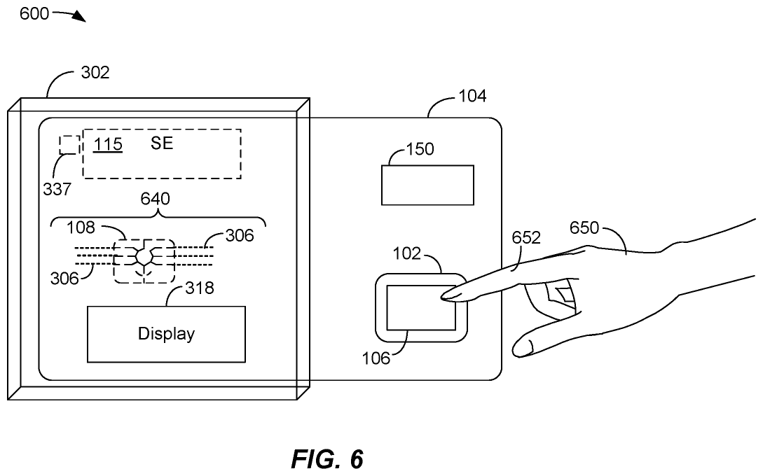

FIG. 6 is a diagram 600 showing the smart card 104 of FIG. 1 making electrical contact with a host device. In an exemplary embodiment, a host device may be a slide on or plug in sleeve 302, as described above. In an exemplary embodiment, a smart card 104 may be inserted into the sleeve 302 so that the sleeve 302 provides temporary power to the smart card 104. In some embodiments, in addition to the sleeve 302 providing temporary power, the sleeve 302 may also exchange other information with the smart card 104.

In an exemplary embodiment, a user 650 may apply a finger 652 to the sensing area 106 of the fingerprint sensor 102 for a number of different actions, one of which being to provide for capture one or more current biometric features, (such as a fingerprint sample) corresponding to a current user identity sample. In an exemplary embodiment, the smart card 104 may be configured to compare the one or more current biometric features obtained from the user 650 to a previously obtained biometric feature corresponding to a previously obtained user identity sample (e.g., a verification template) corresponding to the user 650, as described above.

In an exemplary embodiment, if the one or more current biometric features matches the previously obtained biometric feature, the smart card 104 may be configured to generate an authorization signal that identifies the current user identity sample as belonging to an authorized user, the authorization signal corresponding to a user initiated successful biometric user authentication.

In an exemplary embodiment, the smart card 104 may be configured to generate a temporary passcode using information stored on the card and a dynamically changing variable such as an RTC or another dynamically changing variable that is generated on the powered sleeve 302 using the dynamically changing variable element 337 and transmitted to the smart card 104.

In an exemplary embodiment a dynamically changing variable, such as a RTC signal (or another dynamically changing variable) is accessed by, or generated (i.e., is available to the smart card 104) on the sleeve 302 because it is continually powered by an integrated power source such as a battery. The smart card 104 typically cannot host a dynamically changing variable (e.g., an RTC) function because the smart card 104 is typically powered off when not in a sleeve 302 or performing a transaction using a wired or wireless POS terminal. It is typically not cost effective to have a continuous power source on the smart card 104 to keep an RTC clock chip powered continuously; however, in some embodiments it may be desirable to power the smart card 104 using an on-card power source such as, for example, a battery, a high energy capacitor (referred to as a super capacitor, or super cap), or by another power source so that the smart card 104 may generate a dynamically changing variable in some embodiments.

The temporary passcode may be displayed on the display 318 on the sleeve 302. In an exemplary embodiment, the temporary passcode may be used to authorize at least one transaction and may be generated from a combination of the authorization signal, fixed information previously stored securely on the smart card 104, and the dynamically changing variable generated by the powered sleeve 302. In an exemplary embodiment, the temporary passcode is capable of being shared between the sleeve 302 and the smart card 104.

In an exemplary embodiment, the temporary passcode may be communicated to the sleeve over a communication interface 640 established by the EMVCo. interface (e.g., the contact pads 108 and contacts 306) as described above.

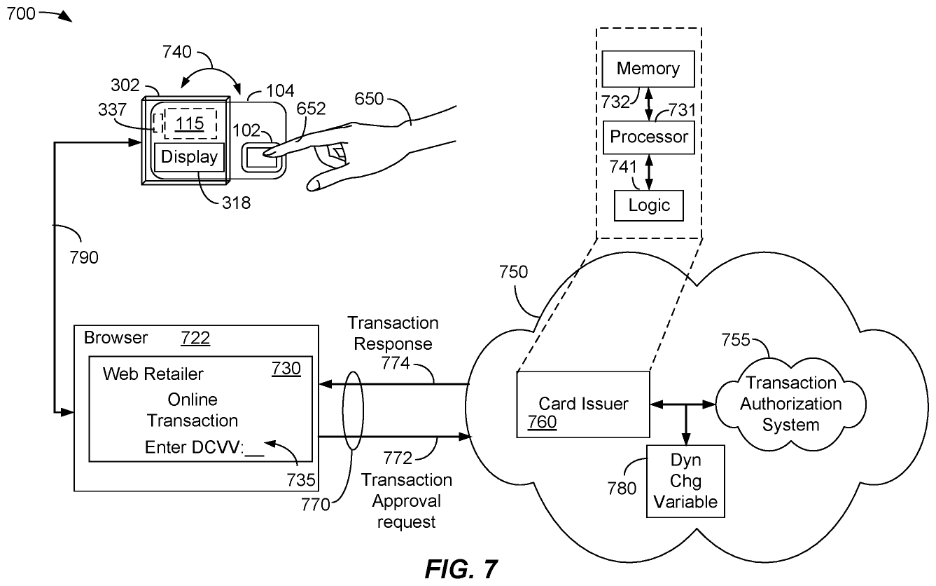

FIG. 7 is a diagram showing an exemplary embodiment of a transaction system 700 including a smart card and a host device. In an exemplary embodiment, the transaction system 700 may comprise the smart card 104 and the host device (the sleeve 302 of FIGS. 3A, 3B, 3C and 6). Some elements in FIG. 7 that are similar to corresponding elements in FIG. 6 are numbered using the nomenclature 7XX, where an element in FIG. 7 labeled 7XX is similar to a corresponding element in FIG. 6 labeled 6XX.

In an exemplary embodiment, the transaction system 700 includes a sleeve 302 and a smart card 104 that may communicate over communication interface 740. In an exemplary embodiment, the sleeve 302 may supply temporary power to the smart card 104 over the communication interface 740. In some embodiments, the sleeve 302 and the smart card 104 may communicate unidirectionally or bidirectionally over communication interface 740, and may communicate securely or non-securely over communication interface 740.

In an exemplary embodiment, the communication interface 740 may be similar to the communication interface 640 described above. In an exemplary embodiment, the communication interface 740 may be a contact interface, such as an interface established by the EMVCo. interface (e.g., the contact pads 108 and contacts 306) as described above. In an exemplary embodiment, the communication interface 740 may also be configured to allow the sleeve 302 to provide temporary power to the smart card 104. In an exemplary embodiment, the communication interface 740 may be configured to allow the sleeve 302 to exchange information (data) with the smart card 104. In an exemplary embodiment, the communication interface 740 is used to provide communications from the sleeve 302 to the smart card 104. In an exemplary embodiment, the communication interface 740 is used to provide communications from the smart card 104 to the sleeve 302.

In an exemplary embodiment, the transaction system 700 may also include a web browser 722 and a network 750. The web browser 722 may by associated with a computing device (not shown), which may be a computer, a smart phone, a tablet, a pad, or any computing device on which a web browser 722 may operate. In an exemplary embodiment, the web browser 722 may be configured to allow a user 750 to access a website of, for example, a web retailer 730.

In an exemplary embodiment, the computing device on which the browser 722 is operating may also be in communication with a network 750. As used herein, the term “network” for the network 750 may comprise one or more distributed computing resources, entities, logic entities, etc. in an exemplary embodiment, the network 750 may include a card issuer 760 and a dynamically changing variable element 780. As used herein, a card issuer 760 may be an entity that creates, manages, oversees, personalizes, and maintains information, including personal and/or confidential information, related to smart cards and users of smart cards. In an exemplary embodiment, the card issuer 760 may also have the ability to create and store user information in a secure manner to the smart card 104 and to archivally store and retrieve user information to calculate the equivalent (or substantially equivalent) temporary passcode used to compare with the card-generated temporary passcode transmitted with a transaction request. The card issuer 760 may also have the ability to generate an equivalent (or substantially equivalent) temporary passcode (such as a DCVV) using the dynamically changing variable element 780, which may generate or have access to a dynamically changing variable (such as a RTC output or value or another dynamically changing variable) as a seed for the equivalent temporary passcode, and has the ability to authorize or deny a transaction, such as a financial transaction or other type of transaction. Among other processing capability, in an exemplary embodiment the card issuer 760 may comprise a processor or processing circuitry 731, memory 732 and logic 741, configured to generate the equivalent (or substantially equivalent) temporary passcode (such as a DCVV) using a dynamically changing variable (such as a RTC output or value or another dynamically changing variable that can be synchronized to) provided by or accessed by the dynamically changing variable element 780.

The network 750 may also comprise a transaction authorization system 755. In an exemplary embodiment, the card issuer 760 may comprise some or all of the transaction authorization system 755; however, in some embodiments, the transaction authorization system 755 may be a separate entity. In some embodiments, the transaction authorization system 755 may reside within the card issuer 760. In an exemplary embodiment, the dynamically changing variable is accessible in real time (or substantially simultaneously accessible) to both the smart card 104 (via the sleeve 302) and to the card issuer 760 (or to the transaction authorization system 755).

In an exemplary embodiment, the web browser 722 may be in communication with the network 750 over a communication interface 770. In an exemplary embodiment, the communication interface 770 may be any communication interface or network that provided wired or wireless connectivity between the web browser 722 and the network 750. In an exemplary embodiment, the network 750 may comprise wireless communication links, such as, for example, WiFi, Bluetooth, cellular, etc., and may comprise wired communication links, such as, for example, a LAN, a WAN, or other communication interface. In an exemplary embodiment, communication from the web browser 722 to the network 750 may occur over a communication link 772 and may be referred to as “upstream” traffic; and communication from the network 750 to the web browser 722 may occur over a communication link 774 and may be referred to as “downstream” traffic. In an exemplary embodiment, the communication interface 770 comprises both communication links 772 and 774. Further, while illustrated as single connections, the communication links 772 and 774 may comprise more than one connection, and may comprise wired and/or wireless communication links. Exemplary embodiments of information that may be communicated over the communication links 772 and 774 include, voice, data, etc., and in some embodiments, may include transaction information.

In an exemplary embodiment, a user 650 may initiate a transaction at a web retailer 730 using the web browser 722. For example, the user may open the web browser 722 and browse to the web retailer 730. The web retailer 730 may establish communication with the card issuer 760. This communication may occur over the communication interface 770.

In an exemplary embodiment, the user 650 may attempt to purchase an item or service from the web retailer 730. Typically, such a transaction falls into the category of a CNP transaction because the user 650 is remote from the web retailer 730. In an exemplary embodiment, as part of the transaction request, the user 650 may provide some information to the web retailer 730, such as name, address, a credit card number, month and expiration of the credit card (smart card), and the CVV code typically printed on the back of a credit card, all of this information being static information may be available to any individual in possession of the smart card 104. However, in some embodiments, to provide additional security, it would be desirable to provide additional information relating to the identity of the user.

In order to make the CNP transaction as secure as possible, it would be desirable to include additional dynamic information to allow the user 650 to complete the transaction. For example, it would be desirable to provide a temporary passcode that may be associated with the user 650, where the temporary passcode can be used as at least one element of data that can be used to authorize the transaction.

For example, in response to the transaction request, the web retailer 730 may request dynamic information, such as a temporary passcode.

In an exemplary embodiment, if not already done so, the user 750 may couple the smart card 104 to the sleeve 302 so that the sleeve 302 may provide temporary power to the smart card 104. For example, the sleeve 302 may provide temporary power to the smart card 104 over the communication interface 740 using, for example, EMVCo. contact technology. In some embodiments, contact-less technology, such as NFC technology, Qi power technology, or another technology for providing wireless power to the smart card 104 may be used. In addition to providing temporary power to the smart card 104, in some embodiments, the sleeve 302 may also exchange other information with the smart card 104.

In an exemplary embodiment, the user 650 may present biometric information in the form of a biometric sample to the smart card 104. For example, the user 650 may present a finger 652 to the fingerprint sensor 102. In this example, the smart card 104 may capture one or more live biometric features corresponding to a current user 650 identity sample, such as a live fingerprint image.

In an exemplary embodiment, the smart card 104 may compare the one or more live biometric features to a previously obtained biometric feature corresponding to a previously obtained user identity sample stored on the card as a verification template, as described above.

If the one or more current biometric features matches the previously obtained biometric feature, the smart card 104 may be configured to generate an authorization signal that identifies the current user identity sample as belonging to an authorized user. In an exemplary embodiment, the authorization signal corresponds to a user initiated successful biometric user authentication.

Once the user 650 is authenticated, the smart card 104 may be configured to generate a temporary passcode. The temporary passcode may be displayed on the display 318 on the sleeve 302. In an exemplary embodiment, the temporary passcode may be, for example, a DCVV code that the user 650 may manually enter into the web retailer 730 using, for example, a passcode entry element 735 on the web browser 722 (or web retailer 730). This manual entry process of a DVCC or similar temporary passcode shown on the display 318 is meant to mimic a procedure currently used on retail websites where the CVV code is read off the back of the physical card and the user keys it into the appropriate field during the checkout procedure along with the credit card number and expiration date.

In some embodiments in order to automate the manual DCVV entry process, there may be a wireless connection established between the sleeve 302 and the browser 722 using additional communications hardware and/or software and/or firmware added to the sleeve 302, such, for example, as Bluetooth or WiFi as known by those having ordinary skill in the art, shown using reference numeral 790. In an exemplary embodiment, the temporary passcode may be communicated to the web retailer 730 using the wireless connection 790 for automatic entry on the web browser 722 (or web retailer 730).

In an exemplary embodiment, the temporary passcode may be generated from a combination of the authorization signal, fixed information previously stored securely on the card, and a dynamically changing variable, the temporary passcode being capable of being shared between the host device and the smart card.

In an exemplary embodiment, the dynamically changing variable may be any publicly known information that may act as a seed for an algorithm that may be used to generate the temporary passcode, as described herein. In an exemplary embodiment, the dynamically changing variable may be accessed by, or generated by the sleeve 302 or by the smart card 104. In an exemplary embodiment, the dynamically changing variable may comprise a card-based RTC value and may be generated by the smart card 104.

In an exemplary embodiment, after the user 650 enters the card-generated temporary passcode (such as a DVCC), a transaction approval request is sent from the web retailer 730 to the card issuer 760. For example, the transaction approval request may be sent over the communication link 772.

In an exemplary embodiment, the card issuer 760 receives the transaction approval request, and in an exemplary embodiment, the card issuer 760 uses the same (or substantially the same) algorithm (or instance of the algorithm) as the smart card 104 to independently generate the same (equivalent or substantially equivalent) temporary passcode (such as a DCVV) using the dynamically changing variable as the seed, along with the fixed information previously stored securely on the smart card 104. The card issuer 760 (or the transaction authorization system 755) compares the card-generated temporary passcode sent over the communication link 772 (the transaction approval request) with the equivalent temporary passcode generated by the card issuer 760 (or the transaction authorization system 755).

If the equivalent temporary passcode matches the card-generated temporary passcode generated by the smart card 104, the card issuer 760 (and/or the transaction authorization system 755) proceeds to approve the transaction approval request. In an exemplary embodiment, the dynamically changing variable is accessible in real time (or substantially simultaneously accessible) to both the smart card 104 (in some embodiments via the sleeve 302) and the transaction authorization system 755.

In an exemplary embodiment, a transaction response is sent from the card issuer 760 to the web retailer 730. For example, the transaction response, whether an approval or a denial, may be sent over the communication link 774.

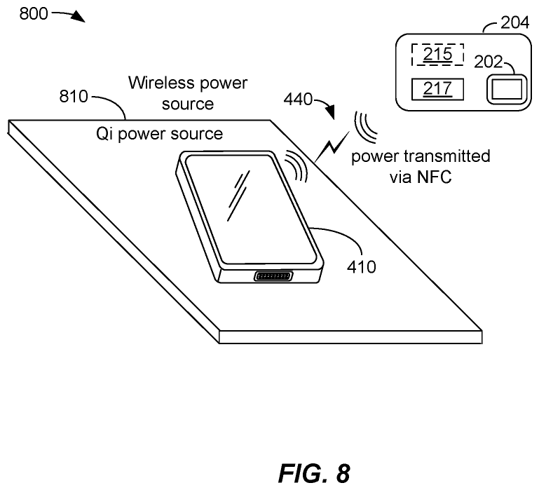

FIG. 8 is a diagram showing an exemplary embodiment of a power system 800. In an exemplary embodiment, a power system 800 may comprise a wireless power source 810, a smart phone 410 and a smart card 204. In an exemplary embodiment, the wireless power source 810 may comprise a Qi power source, or another wireless power source. In an exemplary embodiment, the wireless power source 810 may provide wireless power to the smart phone 410, and the smart phone 410 may then wirelessly transfer power to the smart card 204 over communication interface 440. For example, the smart phone may receive Qi power from the wireless power source 810, and then transfer power to the smart card 204 using, for example, an NFC communication interface.

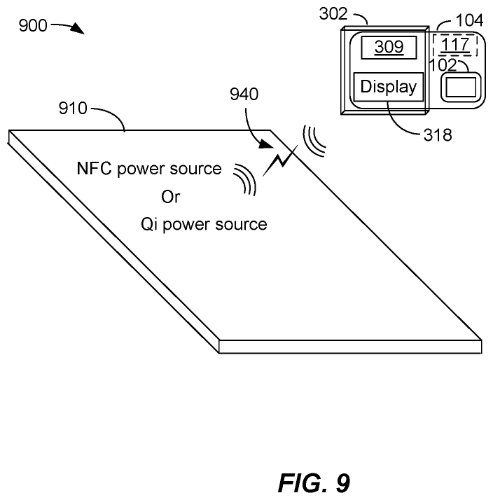

FIG. 9 is a diagram showing an exemplary embodiment of a power system 900. In an exemplary embodiment, a power system 900 may comprise a wireless power source 910, a sleeve 302 and a smart card 104. In an exemplary embodiment, the wireless power source 910 may comprise an NFC power source, a Qi power source, or another wireless power source. In an exemplary embodiment, the wireless power source 910 may provide wireless power to the sleeve 302 and/or to the smart card 104 over communication interface 940. For example, the communication interface 940 may comprise an NFC interface, a Qi power interface, or another communication interface.

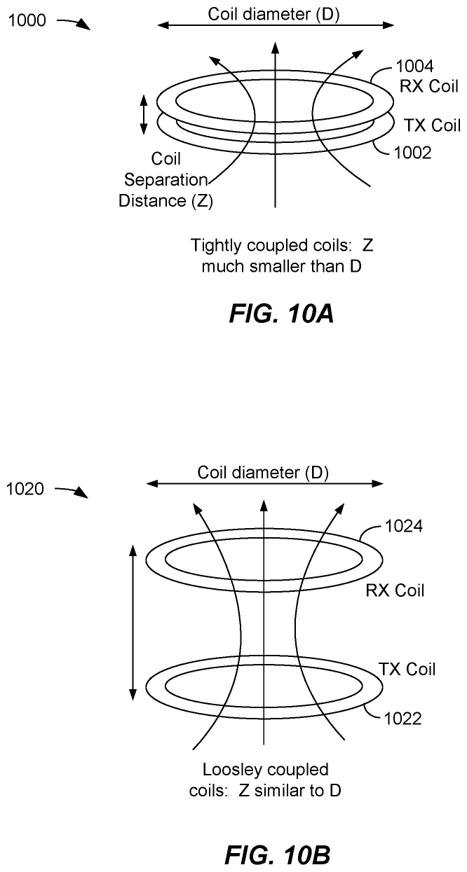

FIGS. 10A and 10B are diagrams showing examples of wireless power coupling. FIG. 10A is an example of a wireless power transfer system 1000 in which a transmit coil 1002 and a receive coil 1004 are considered tightly coupled. FIG. 10B is an example of a wireless power transfer system 1020 in which a transmit coil 1022 and a receive coil 1024 are considered loosely coupled.

In an exemplary embodiment, many Qi or NFC transmitters use tight coupling between coils. Such an operating mode is referred to as “inductive”. The transmit and receive coils are tightly coupled when the coils have the same, or similar, size, and (b) the distance between the coils is much less than the diameter of the coils. Tightly coupled systems, because of their higher efficiency, tend to produce less heat which is an advantage in systems with tight thermal budgets such as modern smart phones.

When the distance between receiver and transmitter increases, the magnetic coupling between the coils decreases. Systems with a low coupling factor may be referred to as “loosely coupled” and typically operate at the resonant frequency of the receiver. Loosely coupled systems trade-off larger distance at the cost of lower power transfer efficiency and higher electromagnetic emissions. This may be a suitable choice in applications where tightly aligned coils are impractical, but less suitable for applications with tight EMI or EMF or efficiency requirements.

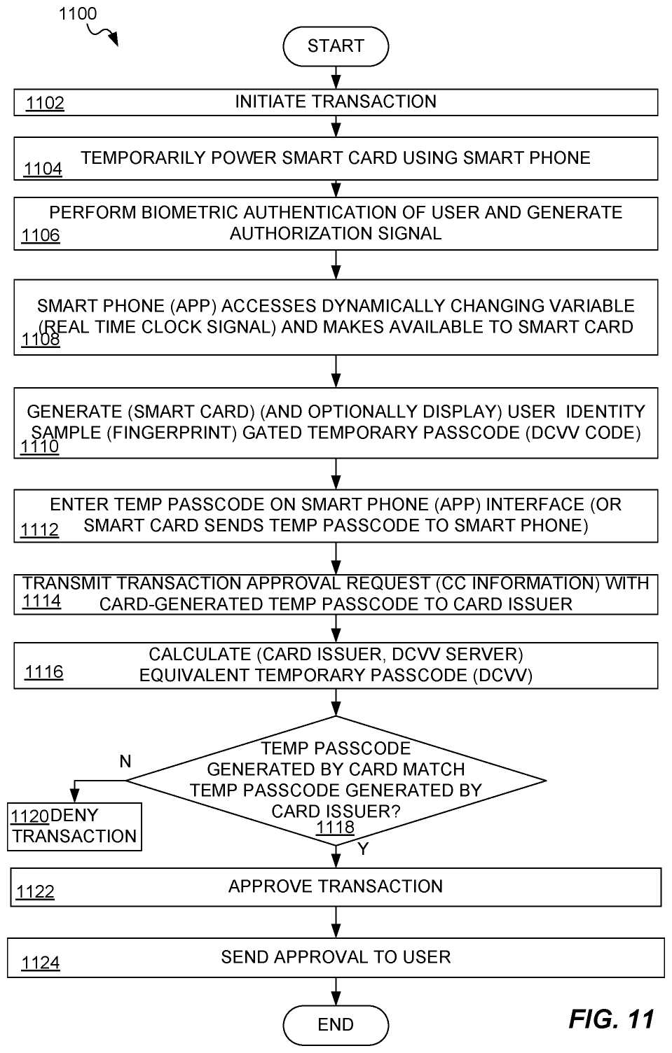

FIG. 11 is a flow chart 1100 is a flow chart describing an example of the operation of a method 1100 for card not present transaction authorization. The blocks in the method 1100 can be performed in or out of the order shown, and in some embodiments, can be performed at least in part in parallel. In an exemplary embodiment, the method in FIG. 11 uses a powered internet connected smart device, such as a smart phone, a tablet, a laptop, or another internet connected smart device. In an exemplary embodiment, the method 1100 will be described using a smart phone as the host device.

In block 1102, a transaction is initiated. For example, a user 450 may initiate a transaction using the smart phone 410. For example, the user may open a web browser 422 and browse to a web retailer 430. In an exemplary embodiment, the user 450 may attempt to purchase an item or service from the web retailer 430. In response to the transaction request, the web retailer 430 may request dynamic information from the user 450, such as a temporary passcode.

In block 1104, the user 450 may couple the smart card 204 to the smart phone 410 so that the smart phone 410 may provide temporary power to the smart card 204. For example, the smart phone 410 may provide temporary power to the smart card 204 over the communication interface 440 using, for example, NFC technology, Qi power technology, or another technology for providing wireless power that the smart card 204 may harvest.

In block 1106, the user 450 may present biometric information in the form of a biometric sample to the smart card 204. For example, the user 450 may present a finger 452 to the biometric (fingerprint) sensor 202. In this example, the smart card 204 may capture one or more current (e.g., a live fingerprint sample) biometric features corresponding to a current user 450 identity sample. In an exemplary embodiment, the smart card 204 may compare the one or more current (live) biometric features to a previously obtained biometric feature corresponding to a previously obtained user identity sample, such as, for example, a verification template of biometric (e.g., fingerprint) data. If the one or more current (live) biometric features matches the previously obtained biometric feature, the smart card 204 may be configured to generate an authorization signal that identifies the current (live) user identity sample as belonging to an authorized user. In an exemplary embodiment, the authorization signal corresponds to a user initiated successful biometric user authentication.

In block 1108, the smart phone 410 accesses a dynamically changing variable and transfers the dynamically changing variable to the smart card 204. For example, in an exemplary embodiment, the dynamically changing variable may comprise a RTC value and may be accessed by the smart phone 410 and communicated from the smart phone 410 to the smart card 204.

In block 1110, a temporary passcode is generated using an algorithm. For example, once the user 450 is authenticated, the smart card 204 may be configured to generate a temporary passcode. The card-generated temporary passcode may be displayed on the passcode display 432 on the smart phone 410. In an exemplary embodiment, the card-generated temporary passcode may be, for example, a DCVV code.

In block 1112, the temporary passcode may be entered. For example, the user 450 may enter the temporary passcode on the smart phone 410 using the passcode entry element 435. Alternatively, the smart card 204 may transfer the temporary passcode to the smart phone 410 automatically for entry into a web browser 422 (web retailer 430).

In block 1114, after the temporary passcode is provided to the web retailer 430, a transaction approval request is sent from the web retailer 430 to the card issuer 560. For example, the transaction approval request may be sent over the communication link 572.

In block 1116, the card issuer 560 receives the transaction approval request, and in an exemplary embodiment, independently generates the equivalent (or substantially equivalent) temporary passcode using the same (or substantially the same) private and/or confidential user information that was programmed into the card during its manufacture (DCVV), as described above.

In block 1118, it is determined whether the card-generated temporary passcode matches the card issuer-generated equivalent temporary passcode using an algorithm similar to that used by the card. If it is determined in block 1118 that the equivalent temporary passcode generated by the card issuer 560 does not match the temporary passcode generated by the smart card 204, the card issuer 560 responds with a transaction response denying the transaction in block 1120.

If it is determined in block 1118 that the equivalent temporary passcode generated by the card issuer 560 matches the temporary passcode generated by the smart card 204, the card issuer 560 proceeds to approve the transaction and the process proceeds to block 1122.

In block 1122, the card issuer 560 sends a transaction response to the web retailer 430 approving the transaction.

In block 1124, the transaction approval is communicated from the web retailer 430 to the user 450.

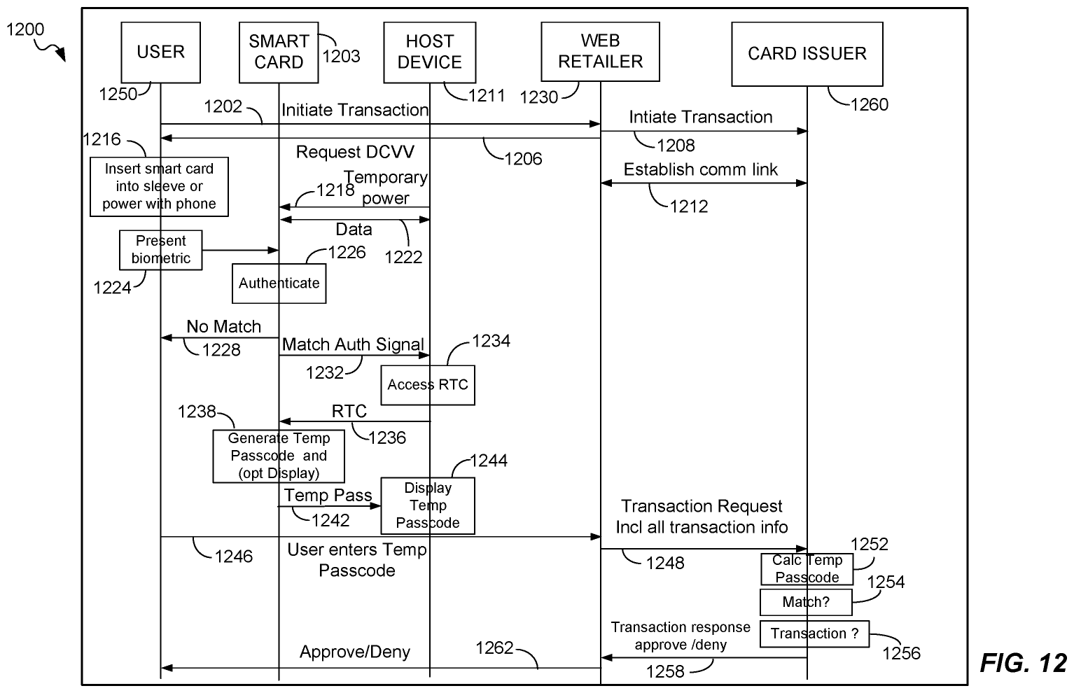

FIG. 12 is a call flow diagram 1200 illustrating an exemplary embodiment of a system and method for card not present authorized user identity verification and subsequent transaction authorization. In an exemplary embodiment, a user 1250, a smart card 1203, a host device 1211, a web retailer 1230 and a card issuer 1260 may interact. In an exemplary embodiment, the smart card 1203 may comprise the smart card 104 (FIG. 1) or the smart card 204 (FIG. 2), and the host device 1211 may comprise the smart phone 410 (FIG. 5) or the sleeve 302 (FIG. 7).

In an exemplary embodiment, in step 1202, a user 1250 may initiate a transaction with the web retailer 1230. For example, the user may open a web browser 422 (FIG. 4) and browse to a web retailer 430.

In step 1206, the web retailer 430 may respond with an acknowledgement. In an exemplary embodiment, in steps 1208 and 1212, the web retailer 430 may also establish communication with the card issuer 560.

In an exemplary embodiment, in block 1216, the user 1250 may couple the smart card 1203 to the host device 1211 so that the host device 1211 may provide temporary power to the smart card 204.

In step 1218, the host device 1211 provides temporary power to the smart card 1203. In addition to providing temporary power to the smart card 1203, in some embodiments, for example, in step 1222, the host device 1211 and the smart card 1203 may also exchange other information. In some embodiments, no data is exchanged, (neither transmitted nor received) between the host device 1211 and the smart card 1203.

In an exemplary embodiment, in step 1224, the user 1250 may present biometric information in the form of a live biometric sample to the smart card 1203. For example, the user 1250 may present a finger 452 (FIG. 4) to the fingerprint sensor 102 or the fingerprint sensor 202. In this example, the smart card 1203 may capture one or more current biometric features corresponding to a current user 1250 identity sample.

In an exemplary embodiment, in block 1226 the smart card 1203 may perform an authentication step or steps. For example, the smart card 1203 may compare the one or more current (live) biometric features of the user 1250 to one or more previously obtained biometric features corresponding to a previously obtained user identity sample (a verification template) corresponding to the user 1250.

If the one or more current biometric features matches the previously obtained biometric feature, in step 1232 the smart card 1203 may be configured to generate an authorization signal that identifies the current user identity sample as belonging to an authorized user. In an exemplary embodiment, the authorization signal corresponds to a user initiated successful biometric user authentication and may be communicated to the host device 1203.

In step 1228, if the smart card 1203 cannot confirm authentication, then the smart card 1203 informs the user that there is not a match.

In step 1234, once the user 1250 is authenticated, the host device 1211 may be configured to access a dynamically changing variable such as an (such as an RTC or another dynamically changing variable that can be synchronized to).

In step 1236, the host device 1211 provides the dynamically changing variable (such as an RTC or another dynamically changing variable that can be synchronized to) to the smart card 1203.

In block 1238, the smart card 1203 generates the temporary passcode. In some embodiments, the smart card 1203 displays the temporary passcode. In some embodiment, the smart card 1203 optionally sends the temporary passcode via step 1242 to the host device. The temporary passcode may be displayed by the host device 1211 in block 1244. In an exemplary embodiment, the temporary passcode may be, for example, a DCVV.

In step 1246, the user 1250 may provide the card-generated temporary passcode to the web retailer 1230.

In an exemplary embodiment, after the user 1250 enters the card-generated temporary passcode, in step 1248 a transaction approval request including the card-generated temporary passcode is sent from the web retailer 1230 to the card issuer 1260.

In an exemplary embodiment, in block 1252 the card issuer 1260 receives the transaction approval request, and in an exemplary embodiment, independently generates an equivalent (or substantially equivalent) temporary passcode (DCVV) using the same (or substantially the same) private user information that was programmed into the card during its manufacture and that was used to generate the card-generated temporary passcode in step 1238.

In block 1254 the card issuer determines if the equivalent temporary passcode generated in block 1252 matches the temporary passcode generated by the smart card 1203 in block 1238. If the equivalent temporary passcode generated by the card issuer 1260 matches the temporary passcode generated by the smart card 1203, in block 1256 the card issuer 1260 approves the transaction. If the equivalent temporary passcode generated by the card issuer 1260 does not match the temporary passcode generated by the smart card 1203, in block 1256 the card issuer 1260 denies the transaction.

In an exemplary embodiment, in step 1258 a transaction response is sent from the card issuer 1260 to the web retailer 1230 with an approval or a denial of the transaction.

In an exemplary embodiment, in step 1262 the transaction response is sent from the web retailer 1230 to the user 1250.

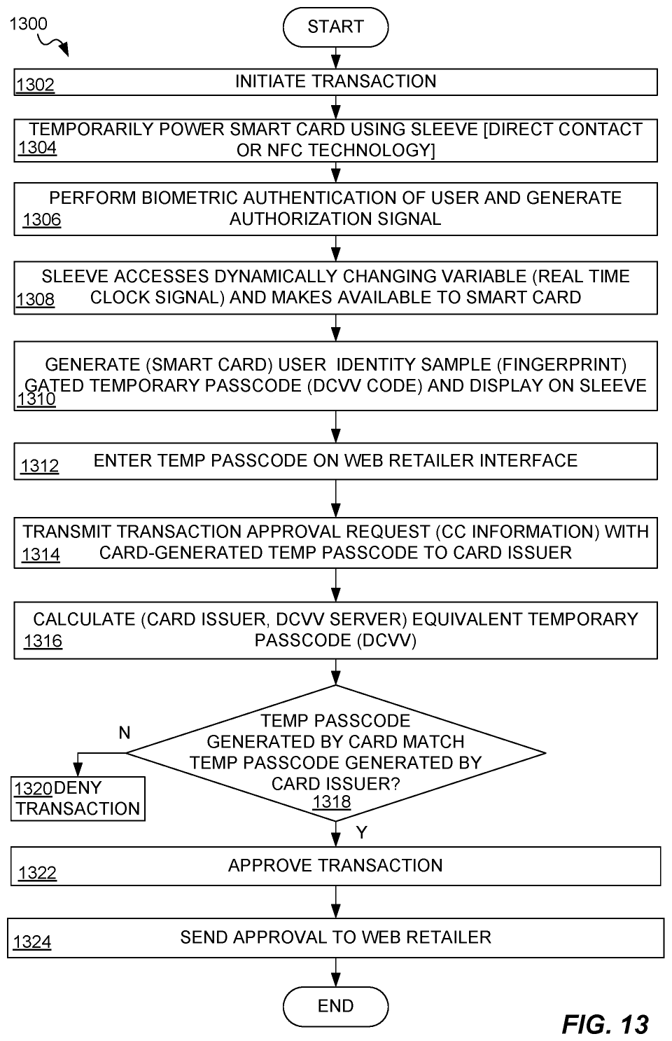

FIG. 13 is a flow chart 1300 describing an example of the operation of a method 1300 for card not present transaction authorization. The blocks in the method 1300 can be performed in or out of the order shown, and in some embodiments, can be performed at least in part in parallel. In an exemplary embodiment, the method in FIG. 13 uses an enrollment sleeve, such as a slide on or plug in sleeve as described herein.

In block 1302, a transaction is initiated. For example, a user 650 may initiate a transaction using a web browser 722 to access a web retailer 730. For example, the user may open a web browser 722 and browse to a web retailer 730. In an exemplary embodiment, the user 650 may attempt to purchase an item or service from the web retailer 730. In response to the transaction request, the web retailer 730 may request dynamic information from the user 650, such as a temporary passcode.

In block 1304, the user 650 may couple the smart card 104 to the sleeve 302 so that the sleeve 302 may provide temporary power to the smart card 104. For example, the sleeve 302 may provide temporary power to the smart card 104 over the communication interface 740 using, for example, direct contact, NFC technology, Qi power technology, or another technology for providing wireless power that the smart card 104 may harvest.

In block 1306, the user 650 may present biometric information in the form of a biometric sample to the smart card 104. For example, the user 650 may present a finger 652 to the biometric (fingerprint) sensor 102. In this example, the smart card 104 may capture one or more current (e.g., a live fingerprint sample) biometric features corresponding to a current user 650 identity sample. In an exemplary embodiment, the smart card 104 may compare the one or more current (live) biometric features to a previously obtained biometric feature corresponding to a previously obtained user identity sample, such as, for example, a verification template of biometric (e.g., fingerprint) data. If the one or more current (live) biometric features matches the previously obtained biometric feature, the smart card 104 may be configured to generate an authorization signal that identifies the current (live) user identity sample as belonging to an authorized user. In an exemplary embodiment, the authorization signal corresponds to a user initiated successful biometric user authentication.

In block 1308, the sleeve 302 accesses a dynamically changing variable and transfers the dynamically changing variable to the smart card 104. For example, in an exemplary embodiment, the dynamically changing variable may comprise a RTC value and may be accessed by the sleeve 302 and communicated from the sleeve 302 to the smart card 104.

In block 1310, a temporary passcode is generated while the smart card 104 is powered by the sleeve 302. For example, once the user 650 is authenticated, the smart card 104 may be configured to generate a temporary passcode using an algorithm configured to generate the temporary passcode. The card-generated temporary passcode may be displayed on the passcode display 318 on the sleeve 302. In an exemplary embodiment, the card-generated temporary passcode may be, for example, a DCVV code.

In block 1312, the temporary passcode may be entered. For example, the user 650 may enter the temporary passcode on the web browser 722 (web retailer 730).

In block 1314, after the temporary passcode is provided to the web retailer 730, a transaction approval request is sent from the web retailer 730 to the card issuer 760. For example, the transaction approval request may be sent over the communication link 772.

In block 1316, the card issuer 760 receives the transaction approval request, and in an exemplary embodiment, independently generates the equivalent (or substantially equivalent) temporary passcode using the same (or substantially the same) private and/or confidential user information that was programmed into the card during its manufacture (DCVV) using an algorithm similar to the algorithm used to generate the card-generated temporary passcode.

In block 1318, it is determined whether the card-generated temporary passcode matches the card issuer-generated equivalent temporary passcode. If it is determined in block 1318 that the equivalent temporary passcode generated by the card issuer 760 does not match the temporary passcode generated by the smart card 104, the card issuer 760 responds with a transaction response denying the transaction in block 1320.

If it is determined in block 1318 that the equivalent temporary passcode generated by the card issuer 760 matches the temporary passcode generated by the smart card 104, the card issuer 760 proceeds to approve the transaction and the process proceeds to block 1322.

In block 1322, the card issuer 760 sends a transaction response to the web retailer 730 approving the transaction.

In block 1324, the transaction approval is communicated from the web retailer 730 to the user 650.

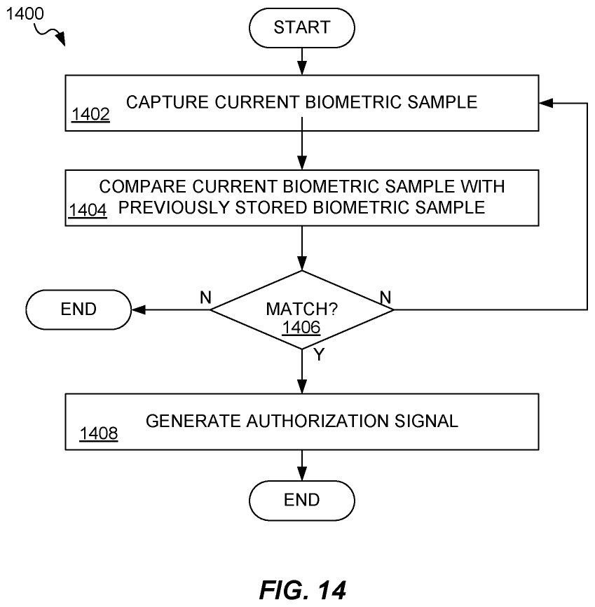

FIG. 14 is a flow chart 1400 describing an example of the operation of a method 1400 for card not present user authentication. The blocks in the method 1400 can be performed in or out of the order shown, and in some embodiments, can be performed at least in part in parallel.

In block 1402, the smart card 104 or 204 may capture one or more current (live) biometric features corresponding to a current user 405 or 650 identity sample.

In block 1404, the smart card 104 or 204 may compare the one or more current (live) biometric features to a previously obtained biometric feature corresponding to a previously obtained user identity sample, such as, for example, a verification template of biometric (e.g., fingerprint) data.

In block 1406 it is determined whether the one or more current (live) biometric features compared in block 1404 matches a previously obtained biometric feature corresponding to a previously obtained user identity sample (a verification template).

If in block 1406 it is determined that the one or more current (live) biometric features matches the previously obtained biometric feature (verification template), the smart card 104 or 204 may be configured to generate an authorization signal in block 1408 that identifies the current user identity sample as belonging to an authorized user. In an exemplary embodiment, the authorization signal corresponds to a user initiated successful biometric user authentication.

If in block 1406 it is determined that the one or more current biometric features does not match the previously obtained biometric feature, the process ends.

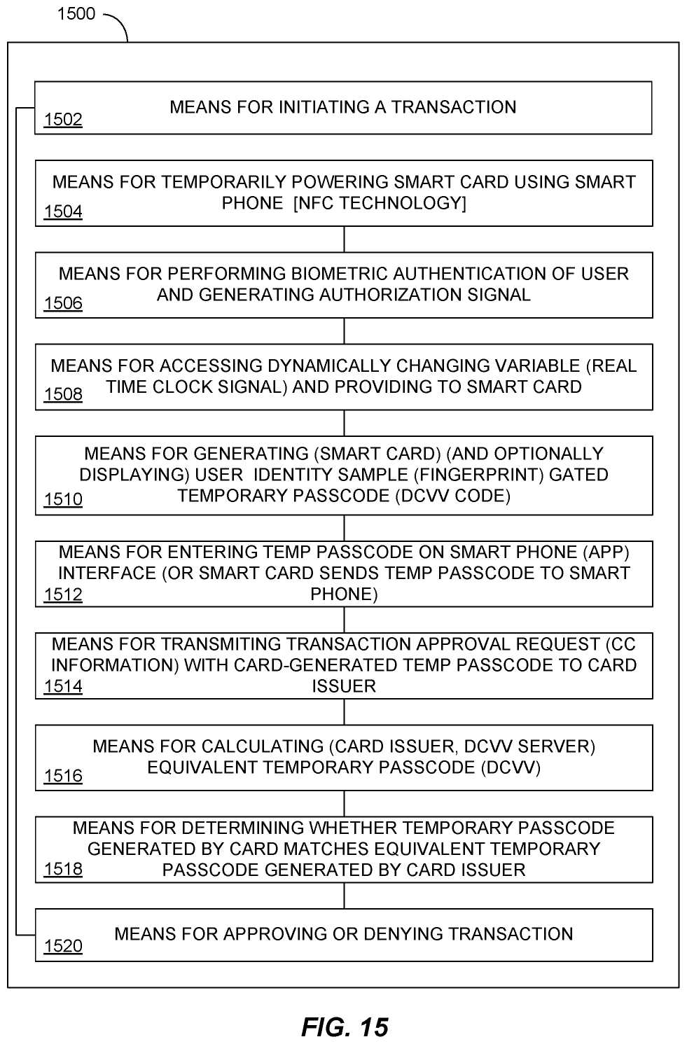

FIG. 15 is a functional block diagram of an apparatus 1500 for card not present transaction authorization. The apparatus 1500 comprises means 1502 for initiating a transaction. In certain embodiments, the means 1502 for initiating a transaction can be configured to perform one or more of the functions described in operation block 1102 of method 1100 (FIG. 11). In an exemplary embodiment, the means 1502 for initiating a transaction comprise a user 450 initiating a transaction using the smart phone 410 and a web retailer 430 requesting dynamic information from the user 450, such as a temporary passcode.

The apparatus 1500 also comprises means 1504 for temporarily powering a smart card. In certain embodiments, the means 1504 for temporarily powering a smart card can be configured to perform one or more of the functions described in operation block 1104 of method 1100 (FIG. 11). In an exemplary embodiment, the means 1504 for temporarily powering a smart card may comprise the smart phone 410 providing temporary power to the smart card 204 over the communication interface 440 using, for example, NFC technology, Qi power technology, or another technology for providing wireless power that the smart card 204 may harvest.

The apparatus 1500 also comprises means 1506 for performing biometric authentication and generating an authorization signal. In certain embodiments, the means 1506 for performing biometric authentication and generating an authorization signal can be configured to perform one or more of the functions described in operation block 1106 of method 1100 (FIG. 11). In an exemplary embodiment, the means 1506 for performing biometric authentication and generating an authorization signal may comprise the smart card 204 capturing one or more current (e.g., a live fingerprint sample) biometric features corresponding to a current user 450 identity sample, comparing the one or more current (live) biometric features to a previously obtained biometric feature corresponding to a previously obtained user identity sample, such as, for example, a verification template of biometric (e.g., fingerprint) data, and if the one or more current (live) biometric features matches the previously obtained biometric feature, generating an authorization signal that identifies the current (live) user identity sample as belonging to an authorized user.

The apparatus 1500 also comprises means 1508 for accessing a dynamically changing variable. In certain embodiments, the means 1508 for accessing a dynamically changing variable can be configured to perform one or more of the functions described in operation block 1108 of method 1100 (FIG. 11). In certain embodiments, the means 1508 for accessing a dynamically changing variable may comprise the smart phone 410 accessing a dynamically changing variable (such as an RTC or another dynamically changing variable that can be synchronized to) and transferring the dynamically changing variable to the smart card 204.

The apparatus 1500 also comprises means 1510 for generating and optionally displaying a temporary passcode. In certain embodiments, the means 1510 for generating and optionally displaying a temporary passcode can be configured to perform one or more of the functions described in operation block 1110 of method 1100 (FIG. 11). In certain embodiments, the means 1510 for generating and optionally displaying a temporary passcode may comprise the smart card 204 generating a temporary passcode. The card-generated temporary passcode may optionally be displayed on the passcode display 432 on the smart phone 410. In an exemplary embodiment, the card-generated temporary passcode may be, for example, a DCVV code.

The apparatus 1500 also comprises means 1512 for entering the temporary passcode. In certain embodiments, the means 1512 for entering the temporary passcode can be configured to perform one or more of the functions described in operation block 1112 of method 1100 (FIG. 11). In certain embodiments, the means 1512 for entering the temporary passcode may comprise the smart card 204 transferring the temporary passcode to the smart phone 410 automatically for entry into a web browser 422 (web retailer 430).

The apparatus 1500 also comprises means 1514 for transmitting a transaction approval request. In certain embodiments, the means 1514 for transmitting a transaction approval request can be configured to perform one or more of the functions described in operation block 1114 of method 1100 (FIG. 11). In certain embodiments, the means 1514 for transmitting a transaction approval request may comprise after the temporary passcode is provided to the web retailer 430, the web retailer 430 sending a transaction approval request to the card issuer 560. For example, the transaction approval request may be sent over the communication link 572.

The apparatus 1500 also comprises means 1516 for calculating an equivalent temporary passcode. In certain embodiments, the means 1516 for calculating an equivalent temporary passcode can be configured to perform one or more of the functions described in operation block 1116 of method 1100 (FIG. 11). In certain embodiments, the means 1516 for calculating an equivalent temporary passcode may comprise the card issuer 560 independently generating the equivalent temporary passcode using the same (or substantially the same) private user information that was programmed into the card during its manufacture (DCVV).

The apparatus 1500 also comprises means 1518 for determining whether the temporary passcode generated by the card matches the equivalent temporary passcode. In certain embodiments, the means 1518 for determining whether the temporary passcode generated by the card matches the equivalent temporary passcode can be configured to perform one or more of the functions described in operation block 1118 of method 1100 (FIG. 11). In certain embodiments, the means 1518 for determining whether the temporary passcode generated by the card matches the equivalent temporary passcode may comprise the card issuer 560 determining whether the card-generated temporary passcode matches the card issuer-generated equivalent temporary passcode.

The apparatus 1500 also comprises means 1520 for making a transaction decision. In certain embodiments, the means 1520 for making a transaction decision can be configured to perform one or more of the functions described in operation blocks 1120 and 1122 of method 1100 (FIG. 11). In certain embodiments, the means 1520 for making a transaction decision may comprise the card issuer 560 approving the transaction if the equivalent temporary passcode generated by the card issuer 560 matches the temporary passcode generated by the smart card 204, and may comprise the card issuer 560 denying the transaction if the equivalent temporary passcode generated by the card issuer 560 does not match the temporary passcode generated by the smart card 204. The approval or denial is sent to the web retailer 430.

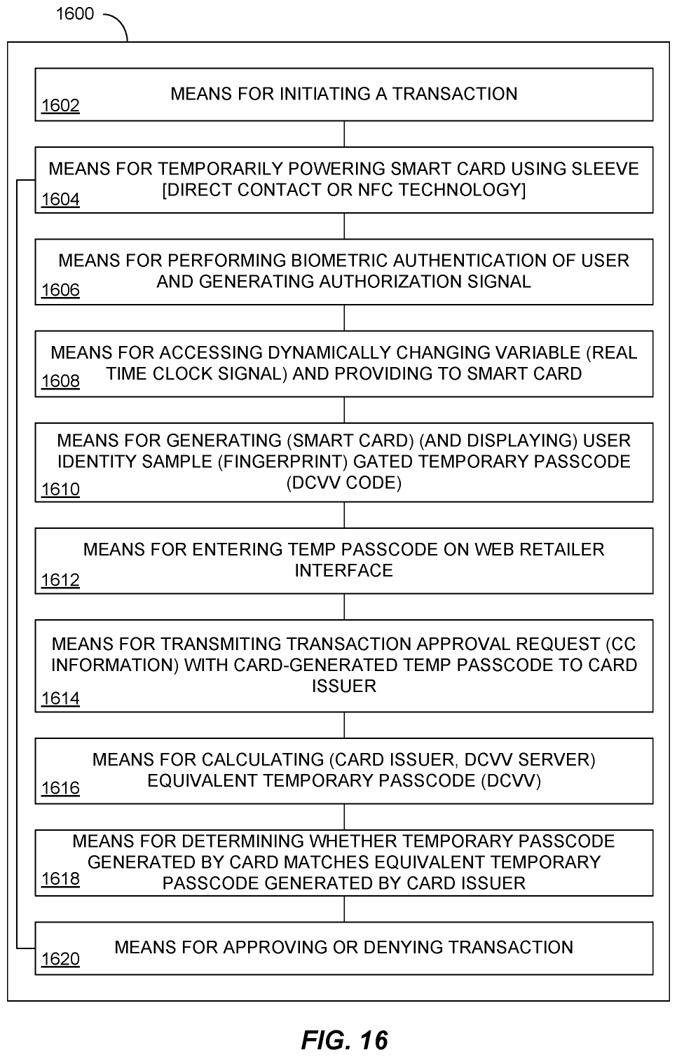

FIG. 16 is a functional block diagram of an apparatus 1600 for card not present transaction authorization. The apparatus 1600 comprises means 1602 for initiating a transaction. In certain embodiments, the means 1602 for initiating a transaction can be configured to perform one or more of the functions described in operation block 1302 of method 1300 (FIG. 13). In an exemplary embodiment, the means 1602 for initiating a transaction may comprise a user 650 initiating a transaction and a web retailer 730 requesting dynamic information from the user 650, such as a temporary passcode.

The apparatus 1600 also comprises means 1604 for temporarily powering a smart card. In certain embodiments, the means 1604 for temporarily powering a smart card can be configured to perform one or more of the functions described in operation block 1304 of method 1300 (FIG. 13). In an exemplary embodiment, the means 1604 for temporarily powering a smart card may comprise the sleeve 302 providing temporary power to the smart card 104 over the communication interface 740 using, for example, direct contact, NFC technology, Qi power technology, or another technology for providing wireless power that the smart card 104 may harvest.

The apparatus 1600 also comprises means 1606 for performing biometric authentication and generating an authorization signal. In certain embodiments, the means 1606 for performing biometric authentication and generating an authorization signal can be configured to perform one or more of the functions described in operation block 1306 of method 1300 (FIG. 13). In an exemplary embodiment, the means 1606 for performing biometric authentication and generating an authorization signal may comprise the smart card 104 capturing one or more current (e.g., a live fingerprint sample) biometric features corresponding to a current user 650 identity sample, comparing the one or more current (live) biometric features to a previously obtained biometric feature corresponding to a previously obtained user identity sample, such as, for example, a verification template of biometric (e.g., fingerprint) data, and if the one or more current (live) biometric features matches the previously obtained biometric feature, generating an authorization signal that identifies the current (live) user identity sample as belonging to an authorized user.

The apparatus 1600 also comprises means 1608 for accessing a dynamically changing variable. In certain embodiments, the means 1608 for accessing a dynamically changing variable can be configured to perform one or more of the functions described in operation block 1308 of method 1300 (FIG. 13). In certain embodiments, the means 1608 for accessing a dynamically changing variable may comprise the sleeve 302 accessing a dynamically changing variable (such as a RTC or another dynamically changing variable that can be synchronized to) and transferring the dynamically changing variable to the smart card 104.

The apparatus 1600 also comprises means 1610 for generating and displaying a temporary passcode. In certain embodiments, the means 1610 for generating and displaying a temporary passcode can be configured to perform one or more of the functions described in operation block 1310 of method 1300 (FIG. 13). In certain embodiments, the means 1610 for generating and displaying a temporary passcode may comprise the smart card 104 generating a temporary passcode. The card-generated temporary passcode may be displayed on the display 318 on the sleeve 302. In an exemplary embodiment, the card-generated temporary passcode may be, for example, a DCVV code.

The apparatus 1600 also comprises means 1612 for entering the temporary passcode. In certain embodiments, the means 1612 for entering the temporary passcode can be configured to perform one or more of the functions described in operation block 1312 of method 1300 (FIG. 13). In certain embodiments, the means 1612 for entering the temporary passcode may comprise the user 650 entering the temporary passcode on the web browser 722 (web retailer 730). Alternatively, the temporary passcode may be communicated to the web retailer 730 using the wireless connection 790 for automatic entry on the web browser 722 (or web retailer 730).

The apparatus 1600 also comprises means 1614 for transmitting a transaction approval request. In certain embodiments, the means 1614 for transmitting a transaction approval request can be configured to perform one or more of the functions described in operation block 1314 of method 1300 (FIG. 13). In certain embodiments, the means 1614 for transmitting a transaction approval request may comprise after the temporary passcode is provided to the web retailer 730, the web retailer 730 sending a transaction approval request to the card issuer 760. For example, the transaction approval request may be sent over the communication link 772.

The apparatus 1600 also comprises means 1616 for calculating an equivalent temporary passcode. In certain embodiments, the means 1616 for calculating an equivalent temporary passcode can be configured to perform one or more of the functions described in operation block 1316 of method 1300 (FIG. 13). In certain embodiments, the means 1616 for calculating an equivalent temporary passcode may comprise the card issuer 760 independently generating the equivalent temporary passcode using the same (or substantially the same) private user information that was programmed into the card during its manufacture (DCVV).

The apparatus 1600 also comprises means 1618 for determining whether the temporary passcode generated by the card matches the equivalent temporary passcode. In certain embodiments, the means 1618 for determining whether the temporary passcode generated by the card matches the equivalent temporary passcode can be configured to perform one or more of the functions described in operation block 1318 of method 1300 (FIG. 13). In certain embodiments, the means 1618 for determining whether the temporary passcode generated by the card matches the equivalent temporary passcode may comprise the card issuer 760 determining whether the card-generated temporary passcode matches the card issuer-generated equivalent temporary passcode.

The apparatus 1600 also comprises means 1620 for making a transaction decision. In certain embodiments, the means 1620 for making a transaction decision can be configured to perform one or more of the functions described in operation blocks 1320 and 1322 of method 1300 (FIG. 13). In certain embodiments, the means 1620 for making a transaction decision may comprise the card issuer 760 approving the transaction if the equivalent temporary passcode generated by the card issuer 760 matches the temporary passcode generated by the smart card 104, and may comprise the card issuer 760 denying the transaction if the equivalent temporary passcode generated by the card issuer 760 does not match the temporary passcode generated by the smart card 104. The approval or denial is sent to the web retailer 730.

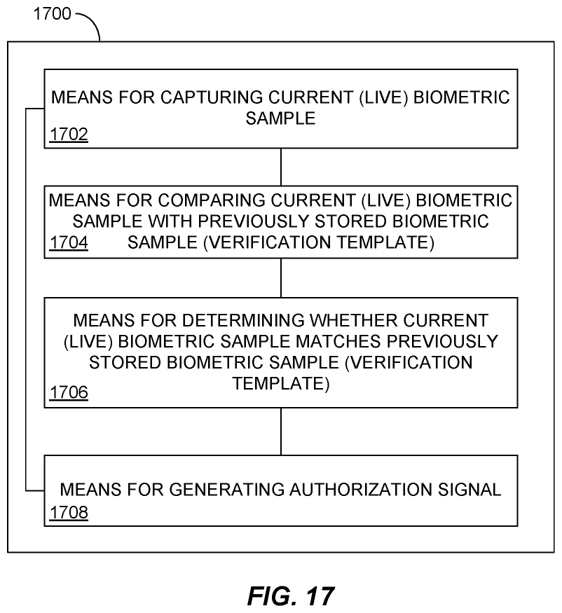

FIG. 17 is a functional block diagram of an apparatus 1700 for performing card not present user authentication. The apparatus 1700 comprises means 1702 for capturing a current (live) biometric sample. In certain embodiments, the means 1702 for capturing a current (live) biometric sample can be configured to perform one or more of the functions described in operation block 1402 of method 1400 (FIG. 14). In an exemplary embodiment, the means 1702 for capturing a current (live) biometric sample may comprise the smart card 104 or 204 capturing one or more current (live) biometric features corresponding to a current user 450 or 650 identity sample.

The apparatus 1700 also comprises means 1704 for comparing the one or more current (live) biometric features to a previously obtained biometric feature. In certain embodiments, the means 1704 for comparing the one or more current (live) biometric features to a previously obtained biometric feature can be configured to perform one or more of the functions described in operation block 1404 of method 1400 (FIG. 14). In an exemplary embodiment, the means 1704 for comparing the one or more current (live) biometric features to a previously obtained biometric feature may comprise the smart card 104 or 204 comparing the one or more current (live) biometric features to a previously obtained biometric feature corresponding to a previously obtained user identity sample, such as, for example, a verification template of biometric (e.g., fingerprint) data.

The apparatus 1700 also comprises means 1706 for determining whether the one or more current (live) biometric features matches a previously obtained biometric feature. In certain embodiments, the means 1706 for determining whether the one or more current (live) biometric features matches a previously obtained biometric feature can be configured to perform one or more of the functions described in operation block 1406 of method 1400 (FIG. 14). In an exemplary embodiment, the means 1706 for determining whether the one or more current (live) biometric features matches a previously obtained biometric feature may comprise the smart card 104 or 204 determining whether the one or more current (live) biometric features matches a previously obtained biometric feature corresponding to a previously obtained user identity sample, such as, for example, a verification template of biometric (e.g., fingerprint) data.

The apparatus 1700 also comprises means 1708 for generating an authorization signal. In certain embodiments, the means 1708 for generating an authorization signal can be configured to perform one or more of the functions described in operation block 1408 of method 1400 (FIG. 14). In an exemplary embodiment, the means 1708 for generating an authorization signal may comprise the smart card 104 or 204 generating an authorization signal that identifies the current user identity sample as belonging to an authorized user. In an exemplary embodiment, the authorization signal corresponds to a user initiated successful biometric user authentication.

Implementation examples are described in the following numbered clauses:

1. A system for card not present (CNP) transaction authorization, comprising:
a smart card having a biometric sensor, a processor, and memory, the processor and memory comprising logic;
a host device configured to communicate with the smart card, the host device configured to provide temporary power to the smart card; and
the biometric sensor and logic configured to capture one or more current biometric features corresponding to a current user identity sample, compare the one or more current biometric features to a previously obtained biometric feature corresponding to a previously obtained user identity sample, and if the one or more current biometric features matches the previously obtained biometric feature, generate an authorization signal that identifies the current user identity sample as belonging to an authorized user, the authorization signal corresponding to a user initiated successful biometric user authentication, the logic configured to generate a temporary passcode for display on the host device, the temporary passcode being used to authorize at least one transaction, the temporary passcode being generated from a combination of the authorization signal, fixed information previously stored securely on the card, and a dynamically changing variable, the temporary passcode being capable of being shared between the host device and the smart card.

2. The system of clause 1, further comprising a display on the smart card, wherein the display is configured to display the temporary passcode.

3. The system of clause 1, further comprising a display on the smart phone, wherein the display is configured to display the temporary passcode.

4. The system of any of clauses 1-3, wherein the communication between the host device and the smart card comprises communicating the temporary passcode from the smart card to the host device.

5. The system of any of clauses 1-4, wherein the communication between the host device and the smart card is one of secure and non-secure.

6. The system of any of clauses 1-5, wherein the fixed information previously stored securely on the card comprises:
user specific information that was previously captured and non-volatilely stored on the smart card by the authorized user during a card initialization and user enrollment process and including information related to at least the previously obtained user identity sample; and individual card specific information previously encrypted and non-volatilely stored on the card during a card personalization process.

7. The system of any of clauses 1-6, wherein the temporary passcode can be valid for a single or limited number of transactions.

8. The system of any of clauses 1-7, wherein the temporary passcode can be valid for a short or a preprogrammed time window.

9. The system of any of clauses 1-8, wherein the temporary passcode comprises a dynamic CVV (DCVV) code.

10. The system of any of clauses 1-9, wherein the dynamically changing variable comprises information that changes over a period of time and is accessible in real time to both the smart card and a transaction authorization system.

11. The system of any of clauses 1-10, wherein the dynamically changing variable comprises an output of a Real Time Clock (RTC) or another numerical sequence.

12. The system of any of clauses 1-11, wherein the temporary passcode may be generated multiple times by the authorized user.

13. The system of any of clauses 1-12, wherein the biometric sensor comprises a fingerprint sensor and the current user identity sample comprises fingerprint information.

14. The system of any of clauses 1-13, wherein the biometric sensor comprises a sensor configured to capture one or more of audio data, image data, electric field data, and ultrasonic data.

15. The system of any of clauses 1-14, wherein the biometric sensor comprises a primary biometric sensor configured to capture a fingerprint, and a secondary biometric sensor configured to capture one or more of audio data, image data, electric field data, and ultrasonic data.

16. The system of any of clauses 1-15, wherein the logic is part of a secure element (SE) and comprises a microcontroller unit (MCU).

17. The system of any of clauses 1-16, wherein the host device securely communicates with the smart card using a non-contact (wireless) interface.

18. The system of clause 17, wherein the non-contact (wireless) interface comprises a near field communication (NFC) connection.

19. The system of any of clauses 1-16, wherein the host device securely communicates with the smart card using a (contact) wired interface.

20. The system of clause 6, wherein the user specific information that was previously captured and non-volatilely stored on the smart card by an authorized user during a card initialization and user enrollment process comprises at least one biometric identifier of the authorized user.

21. The system of clause 6, wherein the individual card specific information previously encrypted and non-volatilely stored on the card during a card personalization process comprises one or more of a unique user account number, expiration date, CVV code, transaction counter and cryptographic key programmed into the smart card during its manufacture.

22. The system of any of clauses 1-21, wherein the at least one transaction comprises a single or limited number of transactions.

23. The system of any of clauses 1-22, wherein the temporary passcode comprises a DCVV that is entered by the authorized user into an electronic transaction authorization system (card issuer).

24. The system of clause 23, wherein the transaction authorization system is configured to compare the DCVV generated by the logic to an equivalent DCVV generated by the transaction authorization system, and if the DCVV generated by the logic matches the equivalent DCVV, the transaction authorization system configured to authorize the CNP transaction.

25. The system of any of clauses 1-24, wherein at least some of the authorization signal, the fixed information previously stored securely on the card, and the dynamically changing variable are encrypted.

26. The system of any of clauses 1-25, wherein a state of the authorization signal is chosen from an undetermined state prior to receiving the current user identity sample, a positive state where the current user identity sample matches the previously obtained user identity sample, and a negative state where the current user identity sample does not match the previously obtained user identity sample.

27. The system of clause 10, wherein an equivalent temporary passcode is generated by the transaction authorization system using the dynamically changing variable.

28. A system for card not present (CNP) transaction authorization, comprising:
a smart card having a biometric sensor; a host device comprising a display, a processor, and memory, the processor and memory comprising logic, the host device configured to communicate with the smart card, the host device configured to provide temporary power to the smart card, the biometric sensor and logic configured to capture one or more current biometric features corresponding to a current user identity sample, compare the one or more current biometric features to a previously obtained biometric feature corresponding to a previously obtained user identity sample, and if the one or more current biometric features matches the previously obtained biometric feature, generate an authorization signal that identifies the current user identity sample as belonging to an authorized user, the authorization signal corresponding to a user initiated successful biometric user authentication, the logic configured to generate a temporary passcode for display on the host device, the temporary passcode being used to authorize at least one transaction, the temporary passcode being generated from a combination of the authorization signal, fixed information previously stored securely on the card, and a dynamically changing variable.

29. The system of clause 28, wherein the host device comprises a sleeve configured to releasably receive the smart card.

30. The system of any of clauses 28-29, wherein the communication between the host device and the smart card comprises communicating the temporary passcode from the smart card to the host device.

31. The system of any of clauses 28-30, wherein the communication between the host device and the smart card is one of secure and non-secure.

32. The system of any of clauses 28-31, wherein the fixed information previously stored securely on the card comprises user specific information that was previously captured and non-volatilely stored on the smart card by the authorized user during a card initialization and user enrollment process and including information related to at least the previously obtained user identity sample; and individual card specific information previously encrypted and non-volatilely stored on the card during a card personalization process.

33. The system of any of clauses 28-32, wherein the temporary code can be valid for a single or limited number of transactions.

34. The system of any of clauses 28-33, wherein the temporary passcode can be valid for a short or a preprogrammed time window.

35. The system of any of clauses 28-34, wherein the temporary code comprises a dynamic CVV (DCVV) code.

36. The system of any of clauses 28-35, wherein the dynamically changing variable comprises information that changes over a period of time and that can be accessible in real time to both the host device and the smart card.

37. The system of any of clauses 28-36, wherein the dynamically changing variable comprises the output of a Real Time Clock (RTC) or other numerical sequence that can be shared between the host device and the smart card.

38. The system of any of clauses 28-37, wherein the temporary passcode may be generated multiple times by the user.

39. The system of any of clauses 28-38, wherein the biometric sensor comprises a fingerprint sensor and the current user identity sample comprises fingerprint information.

40. The system of any of clauses 28-39, wherein the biometric sensor comprises a sensor configured to capture one or more of audio data, image data, electric field data, and ultrasonic data.

41. The system of any of clauses 28-40, wherein the biometric sensor comprises a primary biometric sensor configured to capture a fingerprint, and a secondary biometric sensor configured to capture one or more of audio data, image data, electric field data, and ultrasonic data.

42. The system of any of clauses 28-41, wherein the host device securely communicates with the smart card using a non-contact (wireless) interface.

43. The system of any of clauses 42, wherein the non-contact (wireless) interface comprises a near field communication (NFC) connection.

44. The system of any of clauses 28-43, wherein the host device securely communicates with the smart card using a (contact) wired interface.

45. The system of any of clauses 28-44, wherein the logic is part of a secure element (SE) and comprises a microcontroller unit (MCU).

46. The system of any of clause 45, wherein the smart card comprises a SE and communication of the current user identity sample between the smart card and the host device (sleeve) is encrypted.

47. The system of clause 32, wherein the user specific information that was previously captured and non-volatilely stored on the smart card by an authorized user during a card initialization and user enrollment process comprises at least one biometric identifier of the authorized user.

48. The system of clause 32, wherein the individual card specific information previously encrypted and non-volatilely stored on the card during a card process comprises one or more of a unique user account number representation, expiration date, CVV code, transaction counter and cryptographic key programmed into the smart card during its manufacture.

49. The system of any of clauses 28-48, wherein the at least one transaction comprises a single or limited number of transactions.

50. The system of any of clauses 28-49, wherein the temporary passcode comprises a DCVV that is entered by the authorized user into an electronic transaction authorization system (banking system).

51. The system of any of clauses 28-50, wherein the transaction authorization system is configured to compare the DCVV generated by the logic to an equivalent DCVV generated by the transaction authorization system, and if the DCVV generated by the logic matches the equivalent DCVV, the transaction authorization system configured to authorize the CNP transaction.

52. The system of any of clauses 28-51, wherein at least some of the authorization signal, the fixed information previously stored securely on the card, and the dynamically changing variable are encrypted.

53. The system of any of clauses 28-52, wherein a state of the authorization signal is chosen from an undetermined state prior to receiving the current user identity sample, a positive state where the current user identity sample matches the previously obtained user identity sample, and a negative state where the current user identity sample does not match the previously obtained user identity sample.

54. The system of any of clauses 28-53, wherein the display provides visual feedback of fingerprint orientation on the biometric sensor for a user enrollment process (visual cue for enrollment process).

55. The system of any of clauses 28-54, wherein the host device and the smart card exchange no data.

56. The system of any of clauses 28-55, wherein the host device comprises a sleeve that can be powered by one or more of an internal power source, a NFC interface, and a Qi power source.

57. The system of clause 56, wherein the host device receives power from the Qi power source and transfers the Qi received power to the smart card.

58. The system of clause 56, wherein the host device receives power from the Qi power source and transfers the Qi received power to the smart card via the NFC interface.

59. The system of any of clauses 28-59, wherein an equivalent temporary passcode is generated by the transaction authorization system using the dynamically changing variable.

60. A method for card not present (CNP) transaction authorization, comprising: establishing a communication link between a host device and a smart card; temporarily powering the smart card from a host device, the host device communicating with the smart card; capturing one or more current biometric features corresponding to a current user identity sample; comparing the one or more current biometric features to a previously obtained biometric feature corresponding to a previously obtained user identity sample; if the one or more current biometric features matches the previously obtained biometric feature, generating an authorization signal that identifies the current user identity sample as belonging to an authorized user, the authorization signal corresponding to a user initiated successful biometric user authentication; generating from the authorization signal, a temporary passcode, the temporary passcode being generated from a combination of the authorization signal, fixed information previously stored securely on the card, and a dynamically changing variable; and authorizing at least one transaction using the temporary passcode.

61. The method of clause 60, further comprising displaying the temporary passcode one or more of the host device and the smart card.

62. The method of any of clauses 60-61, further comprising communicating the temporary passcode from the smart card to the host device.

63. The method of clause 62, further comprising communicating one of securely and non-securely between the host device and the smart card.

64. The method of clause 60, wherein the fixed information previously stored securely on the card comprises: user specific information that was previously captured and non-volatilely stored on the smart card by the authorized user during a card initialization and user enrollment process and including information related to at least the previously obtained user identity sample; and individual card specific information previously encrypted and non-volatilely stored on the card during a card personalization process.

65. The method of any of clauses 60-64, wherein the temporary passcode can be valid for a single or limited number of transactions.

66. The method of any of clauses 60-65, wherein the temporary passcode can be valid for a short or a preprogrammed time window.

67. The method of any of clauses 60-66, wherein the temporary passcode comprises a dynamic CVV (DCVV) code.

68. The method of any of clauses 60-67, wherein the dynamically changing variable comprises information that changes over a period of time and is accessible in real time to both the smart card and a transaction authorization system.

69. The method of any of clauses 60-68, wherein the dynamically changing variable comprises an output of a Real Time Clock (RTC) or another numerical sequence.

70. The method of any of clauses 60-69, further comprising generating the temporary passcode multiple times by the authorized user.

71. The method of any of clauses 60-70, wherein the one or more current biometric features and the previously obtained biometric feature comprise fingerprint information.

72. The method of any of clauses 60-71, further comprising capturing one or more of audio data, image data, electric field data, and ultrasonic data.

73. The method of any of clauses 60-72, further comprising capturing one or more of audio data, image data, electric field data, and ultrasonic data.

74. The method of any of clauses 60-73, wherein the capturing and comparing is performed by a secure element (SE) including a microcontroller unit (MCU).

75. The method of any of clauses 60-74, further comprising securely communicating between the host device and the smart card using a non-contact (wireless) interface.

76. The method of clause 75, wherein the non-contact (wireless) interface comprises a near field communication (NFC) connection.

77. The method of any of clauses 60-76, further comprising securely communicating between the host device and the smart card using a (contact) wired interface.

78. The method of clause 64, wherein the user specific information that was previously captured and non-volatilely stored on the smart card by an authorized user during a card initialization and user enrollment process comprises at least one biometric identifier of the authorized user.

79. The method of clause 64, wherein the individual card specific information previously encrypted and non-volatilely stored on the card during a card personalization process comprises one or more of a unique user account number code, expiration date, CVV code, transaction counter and unique cryptographic key programmed into the smart card during its manufacture.

80. The method of any of clauses 60-79, wherein the at least one transaction comprises a single or limited number of transactions.

81. The method of any of clauses 60-80, wherein the temporary passcode comprises a DCVV that is entered by the authorized user into an electronic transaction authorization system (banking system).

82. The method of clause 81, wherein the transaction authorization system compares the DCVV to an equivalent DCVV generated by the transaction authorization system, and if the DCVV matches the equivalent DCVV, the transaction authorization system authorizes the CNP transaction.

83. The method of any of clauses 60-82, further comprising encrypting at least some of the authorization signal, the fixed information previously stored securely on the card, and the dynamically changing variable.

84. The method of any of clauses 60-83, wherein a state of the authorization signal is chosen from an undetermined state prior to receiving the current user identity sample, a positive state where the current user identity sample matches the previously obtained user identity sample, and a negative state where the current user identity sample does not match the previously obtained user identity sample. One or more illustrative or exemplary embodiments of the invention have been described above. However, it is to be understood that the invention is defined by the appended claims and is not limited to the specific embodiments described.

What is claimed is:

1. A system for card not present (CNP) transaction authorization, comprising:
a smart card having a biometric sensor, a processor, and memory, the processor and memory comprising logic;
a host device configured to communicate with the smart card, the host device configured to provide temporary power to the smart card; and
the biometric sensor and logic configured to capture one or more current biometric features corresponding to a current user identity sample, compare the one or more current biometric features to a previously obtained biometric feature corresponding to a previously obtained user identity sample, and if the one or more current biometric features matches the previously obtained biometric feature, generate an authorization signal that identifies the current user identity sample as belonging to an authorized user, the authorization signal corresponding to a user initiated successful biometric user authentication;
the logic configured to generate a temporary passcode for display on the host device, the temporary passcode being used to authorize at least one transaction, the temporary passcode being generated from a combination of the authorization signal, fixed information previously stored securely on the card, and a dynamically changing variable, the temporary passcode being capable of being shared between the host device and the smart card.

2. The system of claim 1, further comprising a display on the smart card, wherein the display is configured to display the temporary passcode.

3. The system of claim 1, further comprising a display on the smart phone, wherein the display is configured to display the temporary passcode.

4. The system of claim 1, wherein the communication between the host device and the smart card comprises communicating the temporary passcode from the smart card to the host device.

5. The system of claim 4, wherein the communication between the host device and the smart card is one of secure and non-secure.

6. The system of claim 1, wherein the fixed information previously stored securely on the card comprises:
user specific information that was previously captured and non-volatilely stored on the smart card by the authorized user during a card initialization and user enrollment process and including information related to at least the previously obtained user identity sample; and
individual card specific information previously encrypted and non-volatilely stored on the card during a card personalization process.

7. The system of claim 1, wherein the temporary passcode can be valid for a single or limited number of transactions.

8. The system of claim 1, wherein the temporary passcode can be valid for a short or a preprogrammed time window.

9. The system of claim 1, wherein the temporary passcode comprises a dynamic CVV (DCVV) code.

10. The system of claim 1, wherein the dynamically changing variable comprises information that changes over a period of time and is accessible in real time to both the smart card and a transaction authorization system.

11. The system of claim 1, wherein the dynamically changing variable comprises an output of a Real Time Clock (RTC) or another numerical sequence.

12. The system of claim 1, wherein the temporary passcode may be generated multiple times by the authorized user.

13. The system of claim 1, wherein the biometric sensor comprises a fingerprint sensor and the current user identity sample comprises fingerprint information.

14. The system of claim 1, wherein the biometric sensor comprises a sensor configured to capture one or more of audio data, image data, electric field data, and ultrasonic data.

15. The system of claim 1, wherein the biometric sensor comprises a primary biometric sensor configured to capture a fingerprint, and a secondary biometric sensor configured to capture one or more of audio data, image data, electric field data, and ultrasonic data.

16. The system of claim 1, wherein the logic is part of a secure element (SE) and comprises a microcontroller unit (MCU).

17. The system of claim 1, wherein the host device securely communicates with the smart card using a non-contact (wireless) interface.

18. The system of claim 17, wherein the non-contact (wireless) interface comprises a near field communication (NFC) connection.

19. The system of claim 1, wherein the host device securely communicates with the smart card using a (contact) wired interface.

20. The system of claim 6, wherein the user specific information that was previously captured and non-volatilely stored on the smart card by an authorized user during a card initialization and user enrollment process comprises at least one biometric identifier of the authorized user.

21. The system of claim 6, wherein the individual card specific information previously encrypted and non-volatilely stored on the card during a card personalization process comprises one or more of a unique user account number, expiration date, CVV code, transaction counter and cryptographic key programmed into the smart card during its manufacture.

22. The system of claim 1, wherein the at least one transaction comprises a single or limited number of transactions.

23. The system of claim 1, wherein the temporary passcode comprises a DCVV that is entered by the authorized user into an electronic transaction authorization system (banking system).

24. The system of claim 23, wherein the transaction authorization system is configured to compare the DCVV generated by the logic to an equivalent DCVV generated by the transaction authorization system, and if the DCVV generated by the logic matches the equivalent DCVV, the transaction authorization system configured to authorize the CNP transaction.

25. The system of claim 1, wherein at least some of the authorization signal, the fixed information previously stored securely on the card, and the dynamically changing variable are encrypted.

26. The system of claim 1, wherein a state of the authorization signal is chosen from an undetermined state prior to receiving the current user identity sample, a positive state where the current user identity sample matches the previously obtained user identity sample, and a negative state where the current user identity sample does not match the previously obtained user identity sample.

27. The system of claim 10, wherein an equivalent temporary passcode is generated by the transaction authorization system using the dynamically changing variable.

28. A system for card not present (CNP) transaction authorization, comprising:
a smart card having a biometric sensor;
a host device comprising a display, a processor, and memory, the processor and memory comprising logic, the host device configured to communicate with the smart card, the host device configured to provide temporary power to the smart card;
the biometric sensor and logic configured to capture one or more current biometric features corresponding to a current user identity sample, compare the one or more current biometric features to a previously obtained biometric feature corresponding to a previously obtained user identity sample, and if the one or more current biometric features matches the previously obtained biometric feature, generate an authorization signal that identifies the current user identity sample as belonging to an authorized user, the authorization signal corresponding to a user initiated successful biometric user authentication;
the logic configured to generate a temporary passcode for display on the host device, the temporary passcode being used to authorize at least one transaction, the temporary passcode being generated from a combination of the authorization signal, fixed information previously stored securely on the card, and a dynamically changing variable.

29. The system of claim 28, wherein the host device comprises a sleeve configured to releasably receive the smart card.

30. The system of claim 28, wherein the communication between the host device and the smart card comprises communicating the temporary passcode from the smart card to the host device.

31. The system of claim 28, wherein the communication between the host device and the smart card is one of secure and non-secure.

32. The system of claim 28, wherein the fixed information previously stored securely on the card comprises:
user specific information that was previously captured and non-volatilely stored on the smart card by the authorized user during a card initialization and user enrollment process and including information related to at least the previously obtained user identity sample; and
individual card specific information previously encrypted and non-volatilely stored on the card during a card personalization process.

33. The system of claim 28, wherein the temporary code can be valid for a single or limited number of transactions.

34. The system of claim 28, wherein the temporary passcode can be valid for a short or a preprogrammed time window.

35. The system of claim 28, wherein the temporary code comprises a dynamic CVV (DCVV) code.

36. The system of claim 28, wherein the dynamically changing variable comprises information that changes over a period of time and that can be accessible in real time to both the host device and the smart card.

37. The system of claim 28, wherein the dynamically changing variable comprises the output of a Real Time Clock (RTC) or other numerical sequence that can be shared between the host device and the smart card.

38. The system of claim 28, wherein the temporary passcode may be generated multiple times by the user.

39. The system of claim 28, wherein the biometric sensor comprises a fingerprint sensor and the current user identity sample comprises fingerprint information.

40. The system of claim 28, wherein the biometric sensor comprises a sensor configured to capture one or more of audio data, image data, electric field data, and ultrasonic data.

41. The system of claim 28, wherein the biometric sensor comprises a primary biometric sensor configured to capture a fingerprint, and a secondary biometric sensor configured to capture one or more of audio data, image data, electric field data, and ultrasonic data.

42. The system of claim 28, wherein the host device securely communicates with the smart card using a non-contact (wireless) interface.

43. The system of claim 42, wherein the non-contact (wireless) interface comprises a near field communication (NFC) connection.

44. The system of claim 28, wherein the host device securely communicates with the smart card using a (contact) wired interface.

45. The system of claim 28, wherein the logic is part of a secure element (SE) and comprises a microcontroller unit (MCU).

46. The system of claim 45, wherein the smart card comprises a SE and communication of the current user identity sample between the smart card and the host device (sleeve) is encrypted.

47. The system of claim 32, wherein the user specific information that was previously captured and non-volatilely stored on the smart card by an authorized user during a card initialization and user enrollment process comprises at least one biometric identifier of the authorized user.

48. The system of claim 32, wherein the individual card specific information previously encrypted and non-volatilely stored on the card during a card personalization process comprises one or more of a unique user account number representation, expiration date, CVV code, transaction counter and cryptographic key programmed into the smart card during its manufacture.

49. The system of claim 28, wherein the at least one transaction comprises a single or limited number of transactions.

50. The system of claim 28, wherein the temporary passcode comprises a DCVV that is entered by the authorized user into an electronic transaction authorization system (banking system).

51. The system of claim 28, wherein the transaction authorization system is configured to compare the DCVV generated by the logic to an equivalent DCVV generated by the transaction authorization system, and if the DCVV generated by the logic matches the equivalent DCVV, the transaction authorization system configured to authorize the CNP transaction.

52. The system of claim 28, wherein at least some of the authorization signal, the fixed information previously stored securely on the card, and the dynamically changing variable are encrypted.

53. The system of claim 28, wherein a state of the authorization signal is chosen from an undetermined state prior to receiving the current user identity sample, a positive state where the current user identity sample matches the previously obtained user identity sample, and a negative state where the current user identity sample does not match the previously obtained user identity sample.

54. The system of claim 28, wherein the display provides visual feedback of fingerprint orientation on the biometric sensor for a user enrollment process (visual cue for enrollment process).

55. The system of claim 28, wherein the host device and the smart card exchange no data.

56. The system of claim 28, wherein the host device comprises a sleeve that can be powered by one or more of an internal power source, a near field communication (NFC) interface, and a Qi power source.

57. The system of claim 56, wherein the host device receives power from the Qi power source and transfers the Qi received power to the smart card.

58. The system of claim 56, wherein the host device receives power from the Qi power source and transfers the Qi received power to the smart card via the NFC interface.

59. The system of claim 36, wherein an equivalent temporary passcode is generated by the transaction authorization system using the dynamically changing variable.

60. A method for card not present (CNP) transaction authorization, comprising:
establishing a communication link between a host device and a smart card;
temporarily powering the smart card from a host device, the host device communicating with the smart card;
capturing one or more current biometric features corresponding to a current user identity sample;
comparing the one or more current biometric features to a previously obtained biometric feature corresponding to a previously obtained user identity sample;
if the one or more current biometric features matches the previously obtained biometric feature, generating an authorization signal that identifies the current user identity sample as belonging to an authorized user, the authorization signal corresponding to a user initiated successful biometric user authentication;
generating from the authorization signal, a temporary passcode, the temporary passcode being generated from a combination of the authorization signal, fixed information previously stored securely on the card, and a dynamically changing variable; and
authorizing at least one transaction using the temporary passcode.

61. The method of claim 60, further comprising displaying the temporary passcode one or more of the host device and the smart card.

62. The method of claim 60, further comprising communicating the temporary passcode from the smart card to the host device.

63. The method of claim 62, further comprising communicating one of securely and non-securely between the host device and the smart card.

64. The method of claim 60, wherein the fixed information previously stored securely on the card comprises:
user specific information that was previously captured and non-volatilely stored on the smart card by the authorized user during a card initialization and user enrollment process and including information related to at least the previously obtained user identity sample; and
individual card specific information previously encrypted and non-volatilely stored on the card during a card personalization process.

65. The method of claim 60, wherein the temporary passcode can be valid for a single or limited number of transactions.

66. The method of claim 60, wherein the temporary passcode can be valid for a short or a preprogrammed time window.

67. The method of claim 60, wherein the temporary passcode comprises a dynamic CVV (DCVV) code.

68. The method of claim 60, wherein the dynamically changing variable comprises information that changes over a period of time and is accessible in real time to both the smart card and a transaction authorization system.

69. The method of claim 60, wherein the dynamically changing variable comprises an output of a Real Time Clock (RTC) or another numerical sequence.

70. The method of claim 60, further comprising generating the temporary passcode multiple times by the authorized user.

71. The method of claim 60, wherein the one or more current biometric features and the previously obtained biometric feature comprise fingerprint information.

72. The method of claim 60, further comprising capturing one or more of audio data, image data, electric field data, and ultrasonic data.

73. The method of claim 60, further comprising capturing one or more of audio data, image data, electric field data, and ultrasonic data.

74. The method of claim 60, wherein the capturing and comparing is performed by a secure element (SE) including a microcontroller unit (MCU).

75. The method of claim 60, further comprising securely communicating between the host device and the smart card using a non-contact (wireless) interface.

76. The method of claim 75, wherein the non-contact (wireless) interface comprises a near field communication (NFC) connection.

77. The method of claim 60, further comprising securely communicating between the host device and the smart card using a (contact) wired interface.

78. The method of claim 64, wherein the user specific information that was previously captured and non-volatilely stored on the smart card by an authorized user during a card initialization and user enrollment process comprises at least one biometric identifier of the authorized user.

79. The method of claim 64, wherein the individual card specific information previously encrypted and non-volatilely stored on the card during a card personalization process comprises one or more of a unique user account number code, expiration date, CVV code, transaction counter and unique cryptographic key programmed into the smart card during its manufacture.

80. The method of claim 60, wherein the at least one transaction comprises a single or limited number of transactions.

81. The method of claim 60, wherein the temporary passcode comprises a DCVV that is entered by the authorized user into an electronic transaction authorization system (banking system).

82. The method of claim 81, wherein the transaction authorization system compares the DCVV to an equivalent DCVV generated by the transaction authorization system, and if the DCVV matches the equivalent DCVV, the transaction authorization system authorizes the CNP transaction.

83. The method of claim 60, further comprising encrypting at least some of the authorization signal, the fixed information previously stored securely on the card, and the dynamically changing variable.

84. The method of claim 60, wherein a state of the authorization signal is chosen from an undetermined state prior to receiving the current user identity sample, a positive state where the current user identity sample matches the previously obtained user identity sample, and a negative state where the current user identity sample does not match the previously obtained user identity sample.
